(19) United States
(12) Patent Application Publication
(10) Pub. No.: US 2026/0106727 A1
(43) Pub. Date: Apr. 16, 2026

(54) BOOTSTRAPPABLE FULLY HOMOMORPHIC ATTRIBUTE-BASED ENCRYPTION METHOD WITH UNBOUNDED CIRCUIT DEPTH

(71) Applicants: Jinan University, Guangzhou (CN); The Hong Kong Polytechnic University, Hong Kong (CN); Nanyang Technological University, Jurong West (SG)

(72) Inventors: Jian WENG, Guangzhou (CN); Shixin CHEN, Guangzhou (CN); Feixiang ZHAO, Hong Kong (CN); Man Ho Allen AU, Hong Kong (CN); Huaxiong WANG, Jurong West (SG); Jian GUO, Jurong West (SG); Chengxin SHU, Guangzhou (CN)

(21) Appl. No.: 19/419,577

(22) Filed: Dec. 15, 2025

(51) Int. Cl. H04L 9/00; H04L 9/08; H04L 9/14

(52) U.S. Cl. CPC H04L 9/008; H04L 9/0894; H04L 9/14

(57) ABSTRACT

Homomorphic attribute-based encryption (HABE) is a useful cryptographic primitive that supports both fine-grained access control and computation over ciphertexts. However, existing HABE schemes are limited to the homomorphic evaluation of circuits with either bounded depth or a restricted number of inputs. To address this problem, the present disclosure introduce a bootstrappable, fully homomorphic attribute-based encryption (FHABE) scheme that supports computations of circuits with unbounded depth over cross-attribute ciphertexts. Compared to state-of-the-art schemes, the proposed scheme also has a more lightweight ciphertext and eliminates the reliance on the random oracle model. Additionally, the present disclosure extend the FHABE to a proxy re-encryption setting, proposing an attribute-based homomorphic proxy re-encryption scheme that facilitates efficient sharing of encrypted data. This scheme is the first lattice-based multi-hop attribute-based proxy re-encryption scheme with unbounded hops of re-encryptions.

### TECHNICAL FIELD

The present invention relates generally to cryptography, and more particularly, to computer-implemented systems and methods for secure data processing in multi-user and untrusted environments. Specifically, the invention pertains to fully homomorphic attribute-based encryption (FHABE) schemes and attribute-based fully homomorphic proxy re-encryption (AB-FHPRE) schemes that enable fine-grained access control and arbitrary computations on encrypted data.

### BACKGROUND

The increasing demand for secure data processing in distributed and multi-user environments, such as cloud computing and outsourced data storage, necessitates advanced cryptographic primitives capable of both granular access control and computations over encrypted information. Two foundational technologies address these needs: Attribute-Based Encryption (ABE) and Homomorphic Encryption (HE).

Attribute-Based Encryption (ABE) allows for fine-grained access control, where data can be encrypted such that only users possessing a specific set of attributes or a secret key derived from an access policy can decrypt the ciphertext. This enables flexible sharing and management of encrypted data across various users. However, conventional ABE schemes are limited to controlling access and do not intrinsically support computations on the encrypted data itself.

Homomorphic Encryption (HE) is a cryptographic primitive that enables computations directly on encrypted data without prior decryption, thereby preserving data confidentiality throughout the computation process. Fully Homomorphic Encryption (FHE) schemes, pioneered by Gentry, support arbitrary computations by utilizing a bootstrapping mechanism to refresh ciphertexts, thereby controlling the accumulation of noise that otherwise limits the number of operations. Advances like FHEW (Ducas and Micciancio) and GINX/TFHE (Chillotti et al.) have significantly improved bootstrapping efficiency. Despite these advancements, traditional FHE schemes primarily operate in a one-to-one model, where encryptions are typically tied to a single user and computations are confined to ciphertexts under the same user's key. This model often lacks the ability to enforce fine-grained access control in multi-user scenarios, such as large organizations requiring data accessibility and manipulability by designated staff members based on their roles or attributes.

To address the combined requirements of computation and fine-grained access, Homomorphic Attribute-Based Encryption (HABE) schemes have been proposed, integrating functionalities from both HE and ABE. Early HABE constructions, such as those based on GSW-FHE, enabled computations only over ciphertexts encrypted under the same attribute set. Subsequent developments introduced Target HABE (T-HABE), which supports computations over cross-attribute ciphertexts. T-HABE is generally categorized into Single-Target HABE (ST-HABE) and Multi-Target HABE (MT-HABE) based on the number of policies supported during computations.

Below is a detailed analysis of the current technical limitations:

Despite these advancements, existing HABE schemes face significant technical limitations that hinder their practical applicability, particularly in complex computational environments:

A paramount limitation of prior art ST-HABE and MT-HABE schemes is their restriction to processing circuits with a predetermined or prior bounded depth. Practical applications often require computations involving complex circuits with unpredictable or effectively unbounded depths. The inability to support such unbounded circuit depth operations severely constrains the computational capacity of these schemes. Specifically, in schemes like BCTW-HABE, the correctness of decryption of homomorphically evaluated ciphertexts is contingent upon the accumulated noise remaining below a certain threshold. The error in an evaluated ciphertext typically grows multiplicatively with each operation, as demonstrated by the formula

$${d}_{G} \leq log M ( \frac{q}{4 ( τ m \sqrt{m} + N + 1 ) B} ) ,$$

where d_{G} is the maximum supported circuit depth, τ, m, N, B are lattice and error parameters. This rapid error growth inherently imposes a significant constraint on the maximum permissible circuit depth.

The parameter sizes in conventional HABE schemes tend to increase substantially with the required circuit depth. This dependency on circuit depth for parameter scaling leads to significant scalability limitations, making these schemes impractical for real-world applications demanding complex or deep computations.

Some proposed HABE constructions, while aiming for unbounded depth, have remained incomplete solutions. For instance, certain schemes may restrict the number of inputs for homomorphic computations or support only “1-hop” computations, meaning evaluated ciphertexts cannot be further processed or re-encrypted. This limitation prevents the construction of complex, multi-stage evaluation processes.

Another technical drawback of some existing HABE schemes is their reliance on the random oracle model for functionalities like secret key generation. Such reliance can sometimes be a concern for provable security in the standard model.

While bootstrapping offers a potential solution to mitigate error accumulation and enable unbounded depth, its direct integration into current HABE schemes presents unique challenges. Bootstrapping typically requires the encryption of secret key bits as part of the public key and necessitates non-interactively deriving attribute or policy information from such keys, which is particularly intricate within the HABE framework. Furthermore, existing HABE schemes support only 1-bit message encryption per ciphertext, leading to excessive ciphertext expansion. For example, BCTW-HABE's ciphertext for a 1-bit message includes two matrices: C∈ [symbol] and Cₓ∈ [symbol] , where M=(m+N+1)┌log q┐. For multi-bit messages, ciphertext size scales linearly with the number of bits, increasing storage and transmission overhead. Additionally, Clear-McGoldrick's generic unbounded HABE lacks a concrete instantiation and restricts input ciphertext counts to 1-hop, making it impractical.

Existing attribute-based proxy re-encryption (AB-PRE) schemes often lack the ability to support multi-hop re-encryptions without depth limitations or to incorporate full homomorphic capabilities, which restricts their utility in dynamic data sharing and evolving access control scenarios. The current AB-PRE schemes (e.g., lattice-based HRA-secure AB-PRE) have two key limitations: 1) No Fully Homomorphic Computations: Existing AB-PRE schemes only support re-encryption, not homomorphic operations on ciphertexts. Users cannot process encrypted data (e.g., aggregate, filter) before or after re-encryption, limiting flexibility in data sharing. 2) Bounded Re-encryption Hops: Re-encrypted ciphertexts accumulate error with each hop, and existing schemes lack a mechanism to refresh error. This restricts re-encryptions to a fixed number of hops (e.g., 1-hop or 2-hop), preventing large-scale, multi-hop data sharing (e.g., across multiple departments or organizations).

These limitations highlight a pressing need for a robust and scalable HABE scheme that can support homomorphic computations of arbitrary complexity (unbounded depth) over cross-attribute ciphertexts, while simultaneously offering efficient re-encryption capabilities across multiple policies without compromising security or performance.

To overcome the deficiencies of the prior art, the present disclosure provides a novel bootstrappable fully homomorphic attribute-based encryption (FHABE) system and method with unbounded circuit depth, and an extended multi-hop attribute-based fully homomorphic proxy re-encryption (AB-FHPRE) system and method. These innovations directly address the technical problems of bounded circuit depth, scalability, incomplete functionality, and restricted re-encryption capabilities inherent in conventional schemes.

### SUMMARY

The present invention achieves unbounded depth and multi-hop re-encryption by integrating advanced bootstrapping techniques with a novel attribute-based encryption framework.

Key technical solutions include: 1) Integrating FHEW-based bootstrapping mechanisms to precisely control noise growth, allowing for an unlimited number of homomorphic operations without needing circuit-depth-dependent parameter scaling. 2) Introducing an auxiliary recovery key (ARK) and associated recovery mechanisms to restore bootstrapped ciphertexts from an expanded key form to a standard, functional ciphertext structure, ensuring compatibility with subsequent evaluation or decryption. 3) Developing specific homomorphic evaluation algorithms (e.g., Eval.NAND) that leverage component-wise bootstrapping to support the computational input of ABE ciphertext, while simultaneously perform parallel processing and efficient noise management. 4) Constructing a novel multi-hop AB-FHPRE scheme that supports an unbounded number of re-encryption hops, enabling dynamic policy updates and secure data sharing across multiple proxies without plaintext exposure.

This is achieved through precisely defined re-encryption key (ReKeyGen) and re-encryption (ReEnc) algorithms with rigorous error bounds. Utilizing lattice-based cryptographic primitives to provide quantum resistance. Eliminating the reliance on the random oracle model, enhancing the provable security of the schemes. The disclosed systems and methods provide a practical and efficient solution for secure and flexible data processing in complex multi-user and multi-policy environments, such as cloud-based encrypted analytics, distributed file systems, and cross-organization data sharing, offering a significant improvement over the limitations of existing cryptographic primitives.

The present disclosure provides a computer-implemented system for fully homomorphic attribute-based encryption (FHABE) with unbounded circuit depth, comprising:
a processor configured to execute instructions; and
a memory coupled to the processor and storing instructions configured to cause the processor to perform operations comprising:
generating public parameters including matrices A, B₁, . . . , Bₗ, U and Gadget matrix G=Iₙ⊗g^{T}, and a master secret key msk;
generating a secret key sk_{ƒ} for an access policy ƒ and an associated public key pk_{ƒ}, wherein the associated public key pk_{ƒ} includes an auxiliary recovery key ark_{ƒ};
encrypting an attribute vector x∈

$${ℤ}_{q}^{l}$$

and a message μ∈(0,1)^{m} associated with the access policy ƒ into a ciphertext ctₓ;
homomorphically evaluating an operation on one or more of the ciphertexts to produce an evaluated ciphertext, wherein the homomorphic evaluation comprises:
   performing a homomorphic arithmetic or logical operation on ciphertext components to achieve a resulting ciphertext component;
   performing a bootstrapping process on the resulting ciphertext component, wherein the bootstrapping process is configured to refresh noise associated with the resulting ciphertext component; and
   applying the auxiliary recovery key ark_{ƒ} to a noise-refreshed ciphertext component to recover the evaluated ciphertext to a standard form compatible with subsequent homomorphic evaluation or decryption; and
decrypting a recovered ciphertext ct using the secret key sk_{ƒ} to retrieve the message μ, wherein correctness of the decryption is maintained for ciphertexts evaluated over an unbounded number of operations.

Preferably, the bootstrapping process utilizes FHEW bootstrapping techniques.

Preferably, the FHEW bootstrapping techniques comprise:
key switching, configured to convert an LWE encryption under a first secret key to an LWE encryption under a second secret key;
modulus switching, configured to convert an LWE encryption under a first modulus to an LWE encryption under a second modulus; and
a homomorphic accumulator, configured to process GSW ciphertexts.

Preferably, the bootstrapping process performs a logical NAND operation, and further comprises:
performing a homomorphic addition on first and second LWE ciphertext components (a⁽¹⁾,b⁽¹⁾) and (a⁽²⁾,b⁽²⁾), under a secret key s and a plaintext modulus t=4, to generate a summed LWE ciphertext component (a, b) that encrypts a sum of plaintext messages μ⁽¹⁾+μ⁽²⁾, wherein the homomorphic addition increases an associated error bound to q/8; and
applying a mapping function ƒ to a value x=b− [symbol] a, s [symbol] of the summed LWE ciphertext component (a, b) via a homomorphic accumulator using a bootstrapping key btk and a key switching key ksk, wherein the mapping function ƒ is configured to transform:

$$x to q / 8 , if x ∈ [ - q / 8 , 3 q / 8 ) ; and x to - q / 8 , if x ∈ [ 3 q / 8 , 7 q / 8 ) ;$$

whereby the mapped value reflects a result of the NAND operation μ⁽¹⁾NANDμ⁽²⁾ with an associated error bound reduced to q/16, wherein q is the ciphertext modulus.

Preferably, the auxiliary recovery key ark_{ƒ} is configured to recover a bootstrapped ciphertext from an expanded key form to a functional ciphertext form compatible with a decryption or homomorphic evaluation algorithm, and wherein:
the auxiliary recovery key ark_{ƒ} comprises a matrix structured as:

$${ark}_{f} = [ \begin{matrix}{M}_{1} & {0}_{2 m \times m} \\ {M}_{2} & {I}_{m \times m}\end{matrix} ] ∈ {ℤ}_{q}^{3 m \times ( 2 m m d + m )}$$

where, M₁=[A|B_{ƒ}]^{T}E₁+E₂, M₂=U^{T}E₁+E₃−P2(R̅_{ƒ})^{T}, E₁ is a randomly chosen matrix uniformly sampled from [symbol] , E₂ and E₃ are error matrices sampled from an error distribution χ with bound B_{χ}, A, B_{ƒ}, U are public parameter matrices defined in the system, with

$$A ∈ {ℤ}_{q}^{n \times m} , {B}_{f} ∈ {ℤ}_{q}^{n \times m} and U ∈ {ℤ}_{q}^{n \times m} ,$$

\hat{R}_{ƒ} is an expanded key matrix after bootstrapping, and
recovering the bootstrapped ciphertext involves computing the functional ciphertext form

$${f}_{( g )}^{}$$

via the matrix multiplication:

$${f}_{( g )}^{} = {ark}_{f} \cdot [ \begin{matrix}{G}^{- 1} ( {\overline{c}}_{f} ) \\ {\overline{c}}_{out}\end{matrix} ]$$

where c̅_{ƒ} and ĉₒᵤₜ are components of the bootstrapped ciphertext in the expanded key form, with

$${\overline{c}}_{f} ∈ {ℤ}_{q}^{2 m m} , {\overline{c}}_{out} ∈ {ℤ}_{q}^{m} ,$$

G⁻¹ is the inverse algorithm of the gadget matrix G, which decomposes a vector into a binary representation;
the functional ciphertext form

$${f}_{( g )}^{}$$

after recovery has an associated error term with a bound less than q/16, where q is the ciphertext modulus, thereby enabling correct decryption and further homomorphic evaluation for unbounded-depth circuits without exceeding the error tolerance; and
the auxiliary recovery key ark_{ƒ} is utilized within an Eval.NAND algorithm to restore ciphertexts after homomorphic evaluation of a NAND gate, enabling their use in subsequent unbounded-depth circuit evaluations.

Preferably, the homomorphic evaluation comprises the Eval.NAND algorithm, and the bootstrapping process is performed on each component of a message vector, wherein:
the Eval.NAND algorithm operates on functioned ciphertexts

$$\hat{c} {t}_{f}^{( i )} = ( {\hat{c}}_{f}^{( i )} , {c}_{out}^{( i )} ) ∈ {ℤ}_{q}^{3 m} for i ∈ \{ 1 , 2 \} ,$$

each encrypting a message vector

$${μ}^{( j )} = ( {μ}_{1}^{( j )} , … , {μ}_{m}^{( j )} ) ∈ {\{ 0 , 1 \}}^{m} for j ∈ \{ 1 , 2 \} ,$$

and comprises:
computing a homomorphic addition

$$a = {\hat{c}}_{f}^{( 1 )} + {\hat{c}}_{f}^{( 2 )} ∈ {ℤ}_{q}^{2 m} , b = ( {b}_{1} , … , {b}_{m} ) = {c}_{out}^{( 1 )} + {c}_{out}^{( 2 )} ∈ {ℤ}_{q}^{m} ;$$

for each component i∈[m], performing a bootstrapping process

$${\overline{c}}_{i} = ( {\overline{a}}_{i} , {\overline{b}}_{i} ) ← {Boot strap}_{( NAND )} ( b t {k}_{{r}_{i}} , ks {k}_{{r}_{i}} , ( a , {b}_{i} ) ) ∈ LW {E}_{{r}_{i}}^{4 / q} ( {μ}_{i}^{( 1 )} \overline{∧} {μ}_{i}^{( 2 )} , δ ) ,$$

where btkᵣ_{ᵢ} is a bootstrapping key and kskᵣ_{ᵢ} is a key-switching key associated with a secret key component rᵢ;
the bootstrapping process is performed independently for each component i∈[m], resulting in a bootstrapped ciphertext c̅t=(c̅_{ƒ}, c̅ₒᵤₜ) with

$${\overline{c}}_{f} = [ {\overline{a}}_{1} \vert … \vert {\overline{a}}_{m} ] ∈ {ℤ}_{q}^{2 mm} and {\overline{c}}_{o u t} = ( {\overline{b}}_{1} , … , {\overline{b}}_{m} ) ∈ {ℤ}_{q}^{m} ,$$

wherein the error bound for each component satisfies δ≤q/16; and
the component-wise bootstrapping enables parallel processing and maintains an overall error bound below q/16, supporting correct decryption and further homomorphic evaluation for unbounded-depth circuits.

Preferably, the system is configured to, during the generation of the public parameters in the Setup algorithm and/or during the homomorphic evaluation process in the Eval algorithm, select parameters that satisfy predefined error bounds to maintain correctness of the encryption scheme, wherein
the error bound for fresh ciphertexts is given by

$${B}_{χ} + 2 m σ ( {α}_{ℱ} + 1 ) {B}_{χ} < \frac{q}{8} ,$$

where B_{χ} is the bound of the error distribution χ, σ is the key sampling parameter used in the SampleD algorithm for generating secret keys, [symbol] =(m+ [symbol] is a policy depth factor with [symbol] being the maximum depth of supported policy circuits, m is the dimension parameter such that m=Θ(n log q), and q is the ciphertext modulus, the chosen parameters, with overwhelming probability, satisfies

$$‖ {e}_{out}^{( i )} - {R}_{f}^{T} [ {e}_{i n}^{( i )} \vert {e}_{f}^{( i )} ] ‖ < {B}_{χ} + 2 m σ ( {α}_{ℱ} + 1 ) {B}_{χ} < \frac{q}{16}$$

for any fresh ciphertext; and
the error bound for evaluated ciphertexts is given by

$$2 {m}^{2} d \cdot {B}_{X} + δ + 2 m σ \cdot 2 {m}^{2} {d}_{g} \cdot {α}_{ℱ} {B}_{X} < \frac{q}{16} ,$$

where d_{g}=┌log_{B}_{_{g}} q┐ is the gadget base decomposition dimension with B_{g} being a gadget base, σ represents an error bound introduced during the bootstrapping process;
satisfying these error bounds allows the system to maintain correctness for homomorphic evaluations of circuits with unbounded depth, without requiring circuit-depth-dependent parameter scaling.

Preferably, the ciphertext ctₓ for a message μ∈{0,1}^{m} associated with an attribute vector

$$x = ( {x}_{1} , … , {x}_{l} ) ∈ {ℤ}_{q}^{l}$$

comprises components ctₓ=(cᵢₙ, c₁, . . . , cₗ, cₒᵤₜ) and wherein:
parameters and matrices are defined with dimensions:

$$A ∈ {ℤ}_{q}^{n \times m} , {B}_{i} ∈ {ℤ}_{q}^{n \times m} for i ∈ [ l ] , U ∈ {ℤ}_{q}^{n \times m} , and G ∈ {ℤ}_{q}^{n \times m}$$

is a gadget matrix, wherein the ciphertext vector overall belongs to

$${ℤ}_{q}^{( l + 2 ) m} ,$$

and m=Θ(n┌log q┐) as per the Setup algorithm;
the mathematical forms and dimensions of the ciphertext components are:

$${c}_{i n} = {A}^{T} s + {e}_{i n} ∈ {ℤ}_{q}^{m} , where s ∈ {ℤ}_{q}^{n}$$

is a random vector;
for each i∈[l],

$${c}_{i} = {( {B}_{i} + {x}_{i} G )}^{T} s + {e}_{i}^{T} ∈ {ℤ}_{q}^{m} ;$$

$${c}_{out} = {u}^{T} s + {e}_{out} + ⌊ q / 4 ⌋ \cdot μ ∈ {ℤ}_{q}^{m} ,$$

where μ is encoded coordinate-wise;
error distributions and bounds: the vectors eᵢₙ, eᵢ for i∈[l] and eₒᵤₜ are independently sampled from an error distribution χ with a constant bound B_{χ} such that ∥eᵢₙ∥_{∞}≤B_{χ}, ∥eᵢ∥_{∞}≤B_{χ}, and ∥eₒᵤₜ∥_{∞}≤B_{χ}, wherein parameter selection during Setup and Eval ensures this bound for correctness;
attribute association: for each i∈[l], the component cᵢ embeds the attribute xᵢ directly, enabling subsequent key-homomorphic evaluation algorithms KeyEval_{ct} or KeyEval_{D} to process access-controlled information based on x;
KeyEval_{ct} result and error bound: for a policy ƒ and attribute x,

$$K {eyEval}_{c t} ( f , x , {\{ {B}_{i} , {c}_{i} \}}_{i = 1}^{l} ) \to {c}_{f} = {D}_{f , x}^{T} \cdot [ {c}_{1} ‖ … ‖ {c}_{l} ] ∈ {ℤ}_{q}^{m} ,$$

and c_{ƒ}=[B_{ƒ}+ƒ(x)G]^{T}·s+e_{ƒ}, where ∥e_{ƒ}∥_{∞}≤(m+ [symbol] . B with [symbol] being the depth of the policy circuit ƒ, ensuring that the functioned ciphertext construction supports correct Eval and decryption.

According to another aspect, the present disclosure provides a computer-implemented system for unbounded multi-hop attribute-based fully homomorphic proxy re-encryption (AB-FHPRE), comprising:
a processor configured to execute instructions; and
a memory coupled to the processor and storing instructions configured to cause the processor to perform operations comprising:
   generating public parameters including matrices A, B₁, . . . , Bₗ, U, and Gadget matrix G, and a master secret key msk;
   generating a secret key sk_{ƒ} for a first access policy ƒ₁ and an associated public key pk_{ƒ}, wherein the associated public key pk_{ƒ} includes an auxiliary recovery key ark_{ƒ} for the first access policy ƒ₁;
   encrypting an attribute vector

$$x ∈ {ℤ}_{q}^{l}$$

and a message μ∈(0,1)^{m} associated with the first access policy ƒ₁ into a ciphertext ct;
generating a re-encryption key rek_{ƒ}_{₁}_{→ƒ}_{₂} for transforming the ciphertext ct from the first access policy ƒ₁ to a second access policy ƒ₂, wherein the re-encryption key rek_{ƒ}_{₁}_{→ƒ}_{₂} is a matrix that combines policy-associated matrices and error matrices, enabling a proxy computing device to convert ciphertexts associated with the first access policy ƒ₁ to those associated with the second access policy ƒ₂ without accessing plaintext; and
re-encrypting, by the proxy computing device, the ciphertext from the first access policy ƒ₁ to the second access policy ƒ₂ using the re-encryption key rek_{ƒ}_{₁}_{→ƒ}_{₂} and a public key of the second policy, wherein the re-encryption comprises:
transforming the ciphertext under the first access policy ƒ₁ into an intermediate re-encrypted ciphertext; and
performing a homomorphic AND computation on the intermediate re-encrypted ciphertext, wherein the homomorphic AND computation includes a bootstrapping process to refresh noise and produce a re-encrypted ciphertext for the second access policy ƒ₂, and wherein the re-encryption supports an unbounded number of re-encryption hops.

Preferably, the re-encryption key is generated by the ReKeyGen algorithm and used by the ReEnc algorithm to re-encrypt a ciphertext under policy ƒ₁ to a ciphertext under policy ƒ₂, and wherein:
the re-encryption key rek_{ƒ}_{₁}_{→ƒ}_{₂} is a block matrix structured as:

$$r e {k}_{{f}_{1} \to {f}_{2}} = [ \begin{matrix}{M}_{1}^{( r )} & {0}_{2 m \times m} \\ {M}_{2}^{( r )} & {I}_{m \times m}\end{matrix} ] ∈ {ℤ}_{q}^{3 m \times ( 2 m \cdot d + m )}$$

where d=┌log_{B}_{_{g}} q┐ is the decomposition length determined by a gadget base B_{g}, and m=Θ(n log q) is the dimension parameter;
the components

$${M}_{1}^{( r )} and {M}_{2}^{( r )}$$

are constructed as follows:
select an attribute vector

$$y = ( {y}_{1} , … , {y}_{l} ) ∈ {ℤ}_{q}^{l}$$

such that ƒ₂(y)=0;
   construct an intermediate matrix

$${\overline{M}}_{1}^{( r )} = {[ A \vert {B}_{1} + {y}_{1} G \vert … \vert {B}_{l} + {y}_{l} G ]}^{⊤} {E}_{1}^{( r )} + {\overline{E}}_{1}^{( r )} , where {E}_{1}^{( r )} {←}^{\$} {ℤ}_{q}^{n \times 2 m d}$$

is a random matrix,

$${\overline{E}}_{2}^{( r )} ← {χ}^{( l + 1 ) m \times 2 md}$$

is an error matrix sampled from distribution χ with bound B_{χ};
evaluate D_{ƒ}_{₂}_{,y}←KeyEval_{D}(ƒ₂, y, (B₁, . . . , Bₗ)), and compute:

$${M}_{1}^{( r )} = {[ \begin{matrix}{I}_{m \times m} & {0}_{m \times m} \\ {0}_{lm \times m} & {D}_{{f}_{2 , y}}\end{matrix} ]}^{⊤} \cdot {\overline{M}}_{1}^{( r )} = {[ A \vert {B}_{{f}_{2}} ]}^{⊤} {E}_{1}^{( r )} + {E}_{2}^{( r )} where {E}_{2}^{( r )}$$

is an error matrix satisfying ∥E₂∥_{∞}< [symbol] ·B_{χ}, [symbol] =(m+ [symbol] is a policy depth factor with [symbol] being the maximum depth of supported policies;
compute

$${M}_{2}^{( r )} = {U}^{⊤} {E}_{1}^{( r )} + {E}_{3}^{( r )} - P 2 {( {R}_{{f}_{1}} )}^{⊤} , where {E}_{3}^{( r )} ← {χ}^{m \times 2 m d}$$

is an error matrix,

$${R}_{{f}_{1}} ∈ {ℤ}_{q}^{2 m \times m}$$

is the secret key for policy ƒ₁, P2 is a public algorithm such that P2(X)=G^{T}X for any matrix X;
the ReEnc algorithm uses rek_{ƒ}_{₁}_{→ƒ}_{₂} and the gadget inverse to compute a 1-hop re-encrypted ciphertext:

$${\overline{c t}}_{{f}_{2}}^{( r )} = r e {k}_{{f}_{1} \to {f}_{2}} \cdot [ \begin{matrix}{G}^{- 1} ( {\hat{c}}_{{f}_{1}} ) \\ {c}_{out}\end{matrix} ] where {\hat{c}}_{{f}_{1}} ∈ {ℤ}_{q}^{2 m} and {c}_{out} ∈ {ℤ}_{q}^{m}$$

are components of the input functioned ciphertext under ƒ₁, and G⁻¹ is the gadget inverse algorithm satisfying G· G⁻¹(x)=x;
perform homomorphic AND computation on

$${\overline{c t}}_{{f}_{2}}^{( r )}$$

and itself:

$${}_{{f}_{2}}^{( r )} ← Eval . AND ( pp , {pk}_{{f}_{2}} , {\overline{c t}}_{{f}_{2}}^{( r )} , {\overline{c t}}_{{f}_{2}}^{( r )} )$$

where Eval.AND consists of a simple addition and a boostrapping algorithm (i.e., Bootstrap_{(AND)}) ober the re-encrypted ciphertext

$${\overline{c t}}_{{f}_{2}}^{( r )}$$

and itself, and it outputs a ciphertext

$${}_{{f}_{2}}^{( r )}$$

preserving the same message but with a lower error state; the matrices and error terms are sampled with respect to public parameters pp including modulus q, gadget matrix G, error distribution χ, and bound B_{χ} such that the accumulated error after re-encryption satisfies ∥error∥_{∞}<q/16, enabling correct decryption; subsequently, a homomorphic refresh operation reduces the error to a level suitable for further re-encryption or homomorphic evaluation, thereby supporting multi-hop re-encryption with unbounded hops;
the re-encryption key rek_{ƒ}_{₁}_{→ƒ}_{₂} is generated by ReKeyGen using the master secret key sk_{ƒ}_{₁} and public parameters pp, and consumed by ReEnc in conjunction with the public key pk_{ƒ}_{₂} to map ciphertexts from policy ƒ₁ to policy ƒ₂.

According to another aspect, the present disclosure provides a computer-implemented method for unbounded depth fully homomorphic attribute-based encryption (FHABE), the method comprising:
generating, by a computing device, public parameters including matrices A, B₁, . . . , Bₗ, U, and Gadget matrix G, and a master secret key msk=T_{A};
generating, by the computing device, a secret key sk_{ƒ} for an access policy ƒ and an associated public key pk_{ƒ}, wherein the associated public key pk_{ƒ} includes an auxiliary recovery key arks;
encrypting, by the computing device, an attribute vector x∈

$${ℤ}_{q}^{l}$$

and a message μ∈(0,1)^{m} associated with the access policy ƒ into a ciphertext ct;
homomorphically evaluating, by the computing device, an operation on one or more of the attribute-based ciphertexts to produce an evaluated ciphertext, wherein the homomorphic evaluation comprises:
   performing a homomorphic arithmetic or logical operation on ciphertext components to achieve a resulting ciphertext component;
   performing a bootstrapping process on the resulting ciphertext component, wherein the bootstrapping process is configured to refresh noise associated with the resulting ciphertext component; and
   applying the auxiliary recovery key ark_{ƒ} to a noise-refreshed ciphertext component to recover the evaluated ciphertext to a standard form compatible with subsequent homomorphic evaluation or decryption; and
decrypting the ciphertext ct using the secret key sk_{ƒ} to retrieve the message μ, wherein correctness of the decryption is maintained for ciphertexts evaluated over an unbounded number of operations.

Preferably, the bootstrapping process utilizes FHEW bootstrapping techniques.

Preferably, the FHEW bootstrapping techniques comprise:
key switching, configured to convert an LWE encryption under a first secret key to an LWE encryption under a second secret key;
modulus switching, configured to convert an LWE encryption under a first modulus to an LWE encryption under a second modulus; and
a homomorphic accumulator, configured to process GSW ciphertexts.

Preferably, the bootstrapping process performs a logical NAND operation, and further comprises:
performing a homomorphic addition on first and second LWE ciphertext components (a⁽¹⁾, b⁽¹⁾) and (a⁽²⁾, b⁽²⁾), under a secret key s and a plaintext modulus t=4, to generate a summed LWE ciphertext component (a, b) that encrypts a sum of plaintext messages μ⁽¹⁾+μ⁽²⁾, wherein the homomorphic addition increases an associated error bound to q/8; and
applying a mapping function ƒ to a value x=b− [symbol] a, s [symbol] of the summed LWE ciphertext component (a, b) via a homomorphic accumulator using a bootstrapping key btk and a key switching key ksk, wherein the mapping function ƒ is configured to transform:

$$x to q / 8 , if x ∈ [ - q / 8 , 3 q / 8 ) ; and$$

$$x to - q / 8 , if x ∈ [ 3 q / 8 , 7 q / 8 ) ;$$

whereby the mapped value reflects a result of the NAND operation μ⁽¹⁾NANDμ⁽²⁾ with an associated error bound reduced to q/16, wherein q is the ciphertext modulus.

Preferably, the auxiliary recovery key ark_{ƒ} is configured to recover a bootstrapped ciphertext from an expanded key form to a functional ciphertext form compatible with a decryption or homomorphic evaluation algorithm, and wherein:
the auxiliary recovery key ark_{ƒ} comprises a matrix structured as:

$$a r {k}_{f} = [ \begin{matrix}{M}_{1} & {0}_{2 , m \times m} \\ {M}_{2} & {I}_{m \times m}\end{matrix} ] ∈ {ℤ}_{q}^{3 m \times ( 2 m m d + m )}$$

where, M₁=[A|B_{ƒ}]^{T}E₁+E₂, M₂=U^{T}E₁+E₃−P2(R̅_{ƒ})^{T}, E₁ is a randomly chosen matrix uniformly sampled from [symbol] , E₂ and E₃ are error matrices sampled from an error distribution χ with bound B_{×}, A, B_{ƒ}, U are public parameter matrices defined in the system, with

$$A ∈ {ℤ}_{q}^{n \times m} , {B}_{f} ∈ {ℤ}_{q}^{n \times m} and U ∈ {ℤ}_{q}^{n \times m} ,$$

R̅_{ƒ} is an expanded key matrix after bootstrapping, and
recovering the bootstrapped ciphertext involves computing the functional ciphertext form

$${f}_{( g )}^{}$$

via the matrix multiplication:

$${f}_{( g )}^{} = {ark}_{f} \cdot [ \begin{matrix}{G}^{- 1} ( {\overline{c}}_{f} ) \\ {\overline{c}}_{out}\end{matrix} ]$$

where c̅_{ƒ} and c̅ₒᵤₜ are components of the bootstrapped ciphertext in the expanded key form, with

$${\overline{c}}_{f} ∈ {ℤ}_{q}^{2 m m} , {\overline{c}}_{out} ∈ {ℤ}_{q}^{m} ,$$

G⁻¹ is the inverse algorithm of the gadget matrix G, which decomposes a vector into a binary representation;
the functional ciphertext form

$${f}_{( g )}^{}$$

after recovery has an associated error term with a bound less than q/16, where q is the ciphertext modulus, thereby enabling correct decryption and further homomorphic evaluation for unbounded-depth circuits without exceeding the error tolerance; and
the auxiliary recovery key ark_{ƒ} is utilized within an Eval.NAND algorithm to restore ciphertexts after homomorphic evaluation of a NAND gate, enabling their use in subsequent unbounded-depth circuit evaluations.

Preferably, the homomorphic evaluation comprises the Eval.NAND algorithm, and the bootstrapping process is performed on each component of a message vector, wherein:
the Eval.NAND algorithm operates on functioned ciphertexts

$$\hat{c} {t}_{f}^{( i )} = ( {\hat{c}}_{f}^{( i )} , {c}_{out}^{( i )} ) ∈ {ℤ}_{q}^{3 m} for i ∈ \{ 1 , 2 \} ,$$

each encrypting a message vector

$${μ}^{( j )} = ( {μ}_{1}^{( j )} , … , {μ}_{m}^{( j )} ) ∈ {\{ 0 , 1 \}}^{m} for j ∈ \{ 1 , 2 \} ,$$

and comprises:
computing a homomorphic addition

$$a = {\hat{c}}_{f}^{( 1 )} + {\hat{c}}_{f}^{( 2 )} ∈ {ℤ}_{q}^{2 m} , b = ( {b}_{1} , … , {b}_{m} ) = {c}_{out}^{( 1 )} + {c}_{out}^{( 2 )} ∈ {ℤ}_{q}^{m} ;$$

for each component i∈[m], performing a bootstrapping process c̅ᵢ=(āᵢ, b̅ᵢ)←Bootstrap_{(NAND)}(btkᵣ_{ᵢ}, kskᵣ_{ᵢ}, (a, bᵢ))∈

$${LWE}_{{r}_{i}}^{4 / q} ( {μ}_{i}^{( 1 )} \overline{∧} {μ}_{i}^{( 2 )} , δ ) ,$$

where btkᵣ_{ᵢ} is a bootstrapping key and kskᵣ_{ᵢ} is a key-switching key associated with a secret key component rᵢ;
the bootstrapping process is performed independently for each component i∈[m], resulting in a bootstrapped ciphertext c̅t=(ĉ_{ƒ}, c̅ₒᵤₜ) with

$${\overline{c}}_{f} = [ {\overline{a}}_{1} \vert … \vert {\overline{a}}_{m} ] ∈ {ℤ}_{q}^{2 m m} and {\overline{c}}_{o u t} = ( {\overline{b}}_{1} , … , {\overline{b}}_{m} ) ∈ {ℤ}_{q}^{m} ,$$

wherein the error bound for each component satisfies δ≤q/16; and
the component-wise bootstrapping enables parallel processing and maintains an overall error bound below q/16, supporting correct decryption and further homomorphic evaluation for unbounded-depth circuits.

Preferably, the system is configured to, during the generation of the public parameters in the Setup algorithm and/or during the homomorphic evaluation process in the Eval algorithm, select parameters that satisfy predefined error bounds to maintain correctness of the encryption scheme, wherein
the error bound for fresh ciphertexts is given by

$${B}_{χ} + 2 m σ ( {α}_{ℱ} + 1 ) {B}_{χ} < \frac{q}{8} ,$$

where B_{χ} is the bound of the error distribution χ, σ is the key sampling parameter used in the SampleD algorithm for generating secret keys, α_{F}=(m+ [symbol] is a policy depth factor with [symbol] being the maximum depth of supported policy circuits, m is the dimension parameter such that m=Θ(n log q), and q is the ciphertext modulus, the chosen parameters, with overwhelming probability, satisfies

$$‖ {e}_{out}^{( i )} - {R}_{f}^{T} [ {e}_{i n}^{( i )} \vert {e}_{f}^{( i )} ] ‖ < {B}_{χ} + 2 m σ ( {α}_{ℱ} + 1 ) {B}_{χ} < \frac{q}{16}$$

for any fresh ciphertext; and
the error bound for evaluated ciphertexts is given by

$$2 {m}^{2} d \cdot {B}_{X} + δ + 2 m σ \cdot 2 {m}^{2} {d}_{g} \cdot {α}_{ℱ} {B}_{X} < \frac{q}{16} ,$$

where d_{g}=┌log_{B}_{_{g}} q┐ is the gadget base decomposition dimension with B_{g} being a gadget base, σ represents an error bound introduced during the bootstrapping process;
satisfying these error bounds allows the system to maintain correctness for homomorphic evaluations of circuits with unbounded depth, without requiring circuit-depth-dependent parameter scaling.

Preferably, the ciphertext ctₓ for a message μ∈{0,1}^{m} associated with an attribute vector

$$x = ( {x}_{1} , … , {x}_{l} ) ∈ {ℤ}_{q}^{l}$$

comprises components ctₓ=(cᵢₙ, c₁, . . . , cₗ, cₒᵤₜ) and wherein:
parameters and matrices are defined with dimensions:

$$A ∈ {ℤ}_{q}^{n \times m} , {B}_{i} ∈ {ℤ}_{q}^{n \times m} for i ∈ [ l ] , U ∈ {ℤ}_{q}^{n \times m} , and G ∈ {ℤ}_{q}^{n \times m}$$

is a gadget matrix, wherein the ciphertext vector overall belongs to

$${ℤ}_{q}^{( l + 2 ) m} ,$$

and m=Θ(n┌log q┐) as per the Setup algorithm;
the mathematical forms and dimensions of the ciphertext components are:

$${c}_{i n} = {A}^{T} s + {e}_{i n} ∈ {ℤ}_{q}^{m} , where s ∈ {ℤ}_{q}^{n}$$

is a random vector;
for each i∈[l],

$${c}_{i} = {( {B}_{i} + {x}_{i} G )}^{T} s + {e}_{i}^{T} ∈ {ℤ}_{q}^{m} ;$$

$${c}_{out} = {U}^{T} s + {e}_{out} + ⌊ q / 4 ⌋ \cdot μ ∈ {ℤ}_{q}^{m} ,$$

where μ is encoded coordinate-wise;
error distributions and bounds: the vectors eᵢₙ, eᵢ for i∈[l] and eₒᵤₜ are independently sampled from an error distribution χ with a constant bound B_{χ} such that ∥eᵢₙ∥_{∞}≤B_{χ}, ∥eᵢ∥_{∞}≤B_{χ}, and ∥eₒᵤₜ∥_{∞}≤B_{χ}, wherein parameter selection during Setup and Eval ensures this bound for correctness;
attribute association: for each i∈[l], the component cᵢ embeds the attribute xᵢ directly, enabling subsequent key-homomorphic evaluation algorithms KeyEval_{ct} or KeyEval_{D} to process access-controlled information based on x;
KeyEval_{ct} result and error bound: for a policy ƒ and attribute x,

$$K {eyEval}_{ct} ( f , x , {\{ {B}_{i} , {c}_{i} \}}_{i = 1}^{l} ) \to {c}_{f} = {D}_{f , x}^{T} \cdot [ {c}_{1} ‖ … ‖ {c}_{l} ] ∈ {ℤ}_{q}^{m} ,$$

and c_{ƒ}=[B_{ƒ}+ƒ(x)G]^{T}·s+e_{ƒ}, where ∥e_{ƒ}∥_{∞}≤(m+ [symbol] ·B with [symbol] being the depth of the policy circuit ƒ, ensuring that the functioned ciphertext construction supports correct Eval and decryption.

### BRIEF DESCRIPTION OF THE DRAWINGS

FIG. 1 illustrates a block diagram of a computer-implemented fully homomorphic attribute-based encryption (FHABE) system according to an embodiment of the present disclosure.

FIG. 2 illustrates a flowchart detailing the computer-implemented method for fully homomorphic attribute-based encryption (FHABE) with unbounded circuit depth, performed by the system described in FIG. 1.

FIG. 3 is a cycle for a simple homomorphic NAND gate evaluation of FHABE.

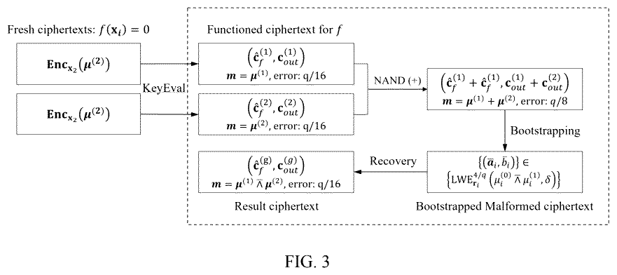

### DETAILED DESCRIPTION OF THE EMBODIMENTS

The present invention provides systems and methods for a fully homomorphic attribute-based encryption (FHABE) scheme with unbounded circuit depth and an attribute-based fully homomorphic proxy re-encryption (AB-FHPRE) scheme. These innovations address significant technical challenges in secure data processing, particularly the limitations of prior art homomorphic encryption and attribute-based encryption schemes with respect to bounded circuit depth, ciphertext explosion, and restricted re-encryption capabilities. The detailed embodiments described herein are fully implementable on computer systems and provide tangible improvements in computational efficiency, data storage, and network transmission.

### I. Overview of the Technical Problem and Solution

Traditional attribute-based encryption (ABE) schemes offer fine-grained access control but lack the ability to perform computations on encrypted data. Conversely, traditional fully homomorphic encryption (FHE) schemes allow arbitrary computations on encrypted data but generally lack fine-grained access control and often suffer from significant ciphertext expansion and limitations on circuit depth. Previous efforts to combine these technologies, such as certain homomorphic attribute-based encryption (HABE) schemes, typically impose restrictions on the circuit depth that can be homomorphically evaluated, or lead to substantial ciphertext sizes, making them impractical for real-world applications requiring complex and scalable computations. The core technical problem addressed by the present disclosure is to provide a comprehensive cryptographic framework that simultaneously supports:

1. Unbounded circuit depth homomorphic computations: Enabling arbitrary and complex operations on encrypted data without prior decryption.

2. Fine-grained attribute-based access control: Allowing data access based on specific attributes and policies.

3. Efficient ciphertext management: Minimizing ciphertext size to optimize storage, transmission, and computation.

4. Secure and multi-hop proxy re-encryption: Facilitating dynamic and granular data sharing in untrusted environments.

The present disclosure overcomes these technical problems by integrating advanced FHE-based bootstrapping techniques with a novel attribute-based encryption framework. A key technical feature is the introduction of an auxiliary recovery key (ARK) that facilitates the recovery of bootstrapped ciphertext components into a standard, functional form, thereby allowing for subsequent evaluations and decryption irrespective of the computation depth. Furthermore, the invention achieves lightweight ciphertexts through specific vector encryption constructions, which significantly reduces the size of encrypted data per message bit. This crucial optimization directly addresses a practical bottleneck in prior art FHE systems, enhancing feasibility in environments with limited storage and bandwidth, and underscores the invention's tangible technical improvement on existing computer systems.

### II. Computer-Implemented FHABE System Architecture

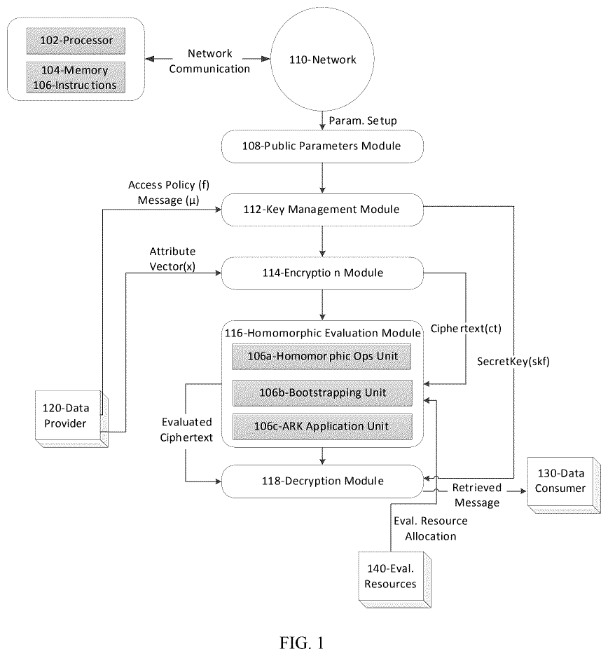

FIG. 1 illustrates a block diagram of a computer-implemented fully homomorphic attribute-based encryption (FHABE) system 100 according to an embodiment of the present disclosure. The system 100 is configured to perform operations including key generation, encryption, homomorphic evaluation, and decryption, leveraging distributed computing resources and secure network communication. The system 100 comprises, or is implemented upon, a computing device that includes a processor 102 and a memory 104 coupled to the processor 102. The memory 104 stores instructions 106 that, when executed by the processor 102, cause the processor to perform the various operations of the FHABE scheme. The system 100 interacts with external entities and components via a network 110, such as a local area network (LAN), wide area network (WAN), or the Internet. The processor 102 and memory 104 are intrinsically linked to the network 110 for communication, with instructions 106 guiding the processor's interactions over the network 110. Within the FHABE system 100, several functional modules are implemented as software instructions executed by the processor 102 and data stored in memory 104:

Public Parameters Module 108: This module is configured to generate public parameters for the FHABE scheme. These parameters typically include cryptographic matrices, such as A, and a Gadget matrix G, vital for the encryption and homomorphic operations. The public parameters are generally made available to all participants in the system. The generation of these parameters forms part of the Setup algorithm, as detailed in S11 and S12 in the fourth section-Technical Details below.

Key Management Module 112: This module is responsible for generating cryptographic keys. Based on a specific access policy ƒ provided by a data provider 120, this module generates a secret key sk_{ƒ} and an associated public key pk_{ƒ}. A critical component of the public key pk_{ƒ} is the auxiliary recovery key ark_{ƒ}, which is essential for enabling unbounded circuit depth by allowing the recovery of bootstrapped ciphertext components to standard form. This activity corresponds to the KeyGen algorithm described in S2 as detailed in the fourth section-Technical Details below, including steps S21 through S28.

Encryption Module 114: This module takes an attribute vector x and a message u associated with the access policy ƒ. Using the public key pk_{ƒ}, it encrypts these inputs into a ciphertext ct. The data provider 120 typically provides the message and attribute vector. The encryption process corresponds to the Encrypt algorithm, outlined in S3 as detailed in the fourth section-Technical Details below, specifically steps S31 through S33. A notable feature here is the lightweight ciphertext construction facilitated by vector encryption, which significantly reduces the ciphertext size compared to traditional FHE, improving storage and network efficiency.

Homomorphic Evaluation Module 116: This is a central module for enabling computations on encrypted data. It includes:

Homomorphic Operations Unit 116a: Configured to execute homomorphic arithmetic or logical operations (e.g., addition, multiplication, NAND gates) on ciphertext components.

Bootstrapping Unit 116b: Configured to perform a bootstrapping process on noise-affected ciphertext components. This unit implements the core mechanism for refreshing ciphertext noise, which is crucial for achieving unbounded circuit depth. This corresponds to the iterative steps mentioned in S4 as detailed in the fourth section-Technical Details below.

ARK Application Unit 116c: Configured to apply the auxiliary recovery key arks to noise-refreshed ciphertext components. This step ensures that the bootstrapped, but potentially non-standard, ciphertext is transformed back into a standard evaluated ciphertext that can be further evaluated or finally decrypted, thereby guaranteeing unbounded computation depth. This is a critical technical contribution enabling the “arbitrary computations” aspect of FHABE. The Homomorphic Evaluation Module 116 can utilize Evaluation Resources 140, represented as external computing power (e.g., cloud-based evaluation servers) connected via the network 110 to efficiently perform complex computations.

Decryption Module 118: This module is configured to decrypt an evaluated ciphertext using the corresponding secret key to retrieve the original message. This module is typically used by a data consumer 130 who possesses the appropriate secret key. This corresponds to the Decrypt algorithm in S5 as detailed in the fourth section-Technical Details below.

### III. FHABE Method Flowchart

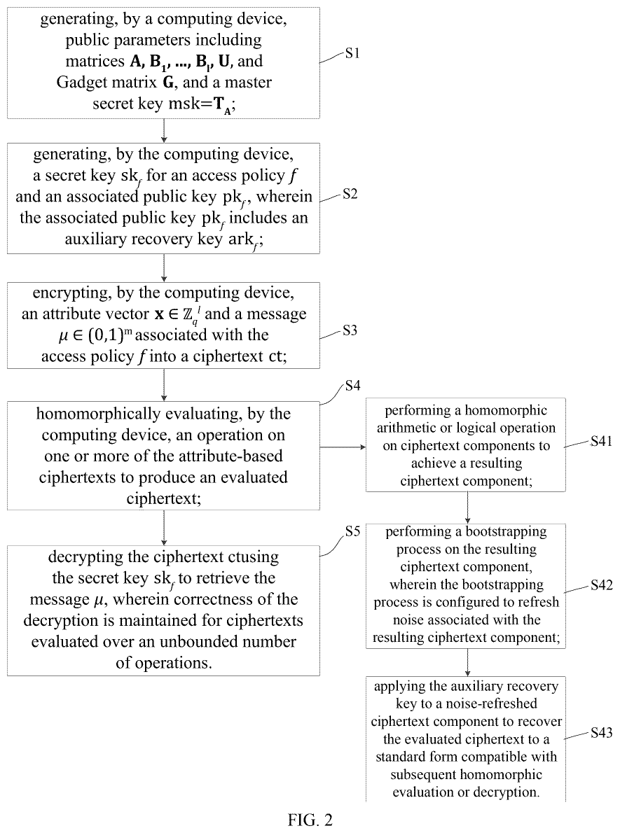

FIG. 2 illustrates a flowchart detailing the computer-implemented method for fully homomorphic attribute-based encryption (FHABE) with unbounded circuit depth, performed by the system described in FIG. 1.

The method begins with START and proceeds as follows:

S1: Generate Public Parameters and Master Secret Key. This initial setup step involves generating global cryptographic parameters and a master secret key. These parameters include matrices (e.g., A) and a Gadget matrix G, as well as a master key msk. This step corresponds to the Setup algorithm, specifically S1 detailed below

S2: Generate Secret Key for Access Policy Public Key, and Auxiliary Recovery Key by Computing Device. On input of existing public parameters, the master secret key msk, and an access policy circuit ƒ, a computing device generates a secret key sk_{ƒ} and an associated public key pk_{ƒ}. Crucially, the public key pks includes an auxiliary recovery key ark_{ƒ}. This step encapsulates the KeyGen algorithm described in S2 detailed below, where S21 evaluates basis, S22 computes elements, S23 samples distribution for error, S24 defines elements through secret components, S25 computes key switch keys, S26 constructs and selects attribute vectors, S27 evaluates and computes ARK, and S28 outputs the keys.

S3: Encrypt Attribute Vector & Message into Ciphertext. An attribute vector x and a message μ are encrypted into a ciphertext ct using the public key pk_{ƒ}. This ciphertext ct is notable for its lightweight construction. This efficiency is a concrete technical improvement. This step corresponds to the Encrypt algorithm, S3 as detailed below, specifically S31 through S33 of choosing random vectors, matrices, and sampling errors.

S4: Homomorphically Evaluate Operation to Produce Evaluated Ciphertext. This is the core homomorphic computation phase, which operates on one or more ciphertexts. This step is designed to achieve unbounded circuit depth capability. It comprises three sub-steps:

S41: Perform Homomorphic Arithmetic/Logical Operation on Ciphertext Components. The system performs operations (e.g., Eval.NAND for a NAND gate) directly on the encrypted ciphertext.

S42: Perform Bootstrapping Process on Resulting Ciphertext Component for Noise Refresh. After each homomorphic operation (or a series of operations), the noise in the ciphertext component accumulates. The bootstrapping process is applied to refresh this noise without decrypting the data, ensuring that further computations remain possible.

S43: Apply Auxiliary Recovery Key to Noise-Refreshed Ciphertext Component to Recover Evaluated Ciphertext to Standard Form Compatible with Eval/Decrypt (Preserving Unbounded Circuit Depth). This is a critical distinguishing feature. The bootstrapped ciphertext component, while noise-refreshed, might not be in a standard, immediately usable form for subsequent evaluations or decryption. The auxiliary recovery key that was generated in S2 is specifically used here to transform the noise-refreshed component back into a standard evaluated ciphertext. This recovery mechanism is what ensures that the system can support an effectively unbounded number of homomorphic operations without requiring circuit-depth-dependent parameter scaling, which is a major advancement over prior art.

S50: Decrypt Evaluated Ciphertext Using Secret Key to Retrieve Message. If the access policy ƒ associated with the secret key sk_{ƒ} is satisfied by the attributes underlying the evaluated ciphertext, the message μ can be successfully retrieved.

### IV. Technical Details

The core steps of the FHABE includes system setup, key generation, encryption, decryption and homomorphic evaluation are described in detail below.

Further, the parameters involved in the present disclosure are described in the present embodiment below.

For a family of policy circuits

$$ℱ = f : {ℤ}_{q}^{l} \to {ℤ}_{q}$$

with a depth bound d_{F}, and a security parameter λ, our construction is parameterized by: n=poly(λ), q=2^{d}. Let m=Θ(n log q), α_{F}=(m+ [symbol] ,

$$G ∈ {ℤ}_{q}^{n \times m}$$

be a Gadget matrix, and χ be a B_{χ}-bounded error distribution so that the DLW E_{n,g,x} problem is hard. Set σ=ω( [symbol] \sqrt{log m}) where [symbol] >\sqrt{n log m}n for the correctness of the trapdoor algorithms. For the RLWE encryption in bootstrapping, set the RLWE modulus

$$Q = {B}_{g}^{{d}_{g}}$$

for some base B_{g}, and N=q/2 as the dimension. Choose a bootstrapping base Bᵣ and a key switching base Bₖₛ. Let χ̅ be an error distribution of parameter σ such that the RLW E_{N,Q,χ̅} problem is hard. Let pp^{LWE}=(n, m, q, χ, σ) and pp^{RLWE}=N, Q, B_{g}, Bᵣ, Bₖₛ, χ̅, σ̅.

For the message space [symbol] ={0,1}^{m}, the method of the present embodiment specifically includes the steps as follows.

S1. Setup(1^{λ}, 1^{l})→(pp, msk). Input the security parameter λ and attribute length l, the setup generates public parameter sets pp and the master key msk as follow:

S11. Generate (A, T_{A})←TrapGen(1ⁿ, 1^{m}, q), where

$$A ∈ {ℤ}_{q}^{n \times m} and {T}_{A} ∈ {ℤ}_{q}^{m \times m}$$

is a basis of

$$( {Λ}_{q}^{⊥} ( A ) ) ;$$

S12. Choose l+1 random matrices

$$( {B}_{1} , … , {B}_{l} , U {=}^{△} {ℤ}_{q}^{n \times m} ) .$$

Output the public parameter pp=(pp^{LWE}, pp^{RLWE}, A, B₁, . . . , Bₗ, U, G) and the master secret key msk=T_{A}.

S2. KeyGen (pp, msk, ƒ)→(pk_{ƒ}, sk_{ƒ}): On input the public parameters pp, the master secret key msk, and an access policy circuit ƒ, the key generation algorithm outputs the key pair (pk_{ƒ}, sk_{ƒ}) with policy ƒ do as follows:
S21. Evaluate B_{ƒ}←KeyEvalₚₖ(ƒ, B₁, . . . , Bₗ);
S22. Compute T_{[A|B}_{_{ƒ}}_{]}←ExtendRight(A, T_{A}, B_{ƒ});
S23. Sample R_{ƒ}←SampleD(A|B_{ƒ}, T_{[A|B}_{_{ƒ}}_{]}, U, σ), such that [A|B_{ƒ}]R_{ƒ}=U;
S24. Let

$${R}_{f} = [ {r}_{1} \vert … \vert {r}_{m} ] ∈ {ℤ}_{q}^{2 m \times m} where {r}_{i} ∈ {ℤ}_{q}^{2 m} for i ∈ [ m ] ,$$

compute:

$$bt {k}_{f} = {( b t {k}_{{r}_{k}} )}_{k = 1}^{m} where {btk}_{{r}_{k}} = ( {ℤ}_{h , i , j}^{( k )} = R G S {W}_{z} ( {X}^{h \cdot {r}_{k} [ i ] \cdot {B}_{i}^{j}} ) )$$

for some secret for some secret z← [symbol] , h∈[0, Bᵣ−1], i∈[2], j∈[0, dᵣ−1], dᵣ=┌log_{B}_{ᵣ} q┐;
S25. Compute key switch key

$${ksk}_{f} = {( k s {k}_{{r}_{k}} )}_{k = 1}^{m} where {ksk}_{{r}_{k}} = ( {k}_{h , i , j}^{( k )} = LW {E}_{{r}_{k}}^{q / Q} ( h {{z}_{i}}^{′} {B}_{k s}^{j} ) )$$

for z′=(z₀, −z_{N-1}, . . . , −z₁), h∈[0, Bₖₛ−1], i∈[N], j∈[0, dₖₛ−1], and dₖₛ=┌log_{B}_{ₖₛ} q┐;
S26. Construct

$${R}_{f} = [ \begin{matrix}{r}_{1} & 0 & ⋯ & 0 \\ 0 & {r}_{2} & ⋯ & 0 \\ ⋮ & ⋮ & ⋱ & ⋮ \\ 0 & 0 & ⋯ & {r}_{m}\end{matrix} ] ∈ {ℤ}_{q}^{2 m \cdot m \times m}$$

Then select any attribute vector

$${x}^{′} = ( {x}_{1}^{′} , ⋯ , {x}_{l}^{′} ) ∈ {ℤ}_{q}^{l}$$

such that ƒ(x′)=0. Construct M₁=[A|B₁+x₁′G| . . . |Bₗ+xₗ′G]^{T}E₁+E₂ and M₂=U^{T}E₁+E₃−P2(R_{ƒ})^{T}, where

$${E}_{1} {←}^{\$} {ℤ}_{q}^{n \times 2 m m d} , {E}_{2} ← {χ}^{( l + 1 ) m \times 2 m m d} ,$$

and E₃←χ^{m×2mmd}.
S27. Evaluate D_{ƒ,x′}←KeyEval_{D}(ƒ,x′, (B₁, . . . , Bₗ)). Then compute the auxiliary recovery key

$${ark}_{f} = [ \begin{matrix}{M}_{1} & {0}_{2 m \times m} \\ {M}_{2} & {I}_{m \times m}\end{matrix} ] ∈ {ℤ}_{q}^{3 m \times ( 2 m m d + m )} , {where [ \begin{matrix}{I}_{m \times m} & {0}_{m \times m} \\ {0}_{m \times m} & {D}_{f , x ′}\end{matrix} ]}^{T} .$$

M₁=[A|B_{ƒ}]^{T}E₁+E₂, for some ∥E₂∥_{∞}<α_{F}·B_{χ};
S28. Output the secret key sk_{ƒ}=R_{ƒ} and public key pk_{ƒ}=(btk_{ƒ}, ksk_{ƒ}, ark_{ƒ}).

S3. Enc (pp,x,μ)→ctₓ: On input an attribute vector

$$x ∈ {ℤ}_{q}^{l}$$

and a message μ∈(0,1)^{m}, the encryption algorithm outputs the ciphertext ct do as follows:
S31. Choose a vector

$$( s {←}^{\$} {ℤ}_{q}^{n} )$$

at uniformly random;
S32. Choose 1 matrices

$$( {S}_{i} {←}^{\$} {( 1 , - 1 )}^{m \times m} )$$

for (i∈[l]) at uniformly random;
S33. Sample errors (e₀, eₒᵤₜ←χ^{m}) and compute

$$e = {[ {I}_{m} \vert {S}_{1} \vert ⋯ \vert {S}_{l} ]}^{T} \cdot {e}_{0} = ( {e}_{i n} , {e}_{1} , ⋯ , {e}_{l} ) ∈ {ℤ}_{q}^{( l + 1 ) m} ;$$

S34. Construct

$${H}_{x} = [ A \vert {B}_{1} + {x}_{1} G \vert ⋯ \vert {B}_{l} + {x}_{l} G ] ∈ {ℤ}_{q}^{n \times ( l + 1 ) m} ;$$

S35. Compute

$$c = {H}_{x}^{T} s + e ∈ {ℤ}_{q}^{( l + 1 ) m} and {c}_{out} = {U}^{T} s + {e}_{out} + ⌊ q / 4 ⌋ \cdot μ ∈ {ℤ}_{q}^{m} .$$

Let c=(cᵢₙ, c₁, . . . , cₗ) for cᵢₙ=A^{T}s+eᵢₙ, cᵢ=(Bᵢ+xᵢG)^{T}s+eᵢ;
S36. Output the ciphertext

$${ct}_{x} = ( {c}_{i n} , {c}_{1} , ⋯ , {c}_{l} , {c}_{out} ) ∈ {ℤ}_{q}^{( l + 2 ) m}$$

along with the attribute vector X.

S4. Dec(pp, sk_{ƒ}, ct)→μ: On input a secret key sk_{ƒ}=R_{ƒ} and a ciphertext ct, the decryption algorithm outputs the message do as follows based on different cases:
S41. If (ct) is a fresh ciphertext, let ct be ctₓ=(cᵢₙ, c₁, . . . , cₗ, cₒᵤₜ), output ⊥ if ƒ(x)≠0; Otherwise, evaluate

$${KeyEval}_{ct} ( f , x , {( {B}_{i} , {c}_{i} )}_{i = 1}^{l} ) \to {c}_{f} = {[ {B}_{f} + f ( x ) G ]}^{T} \cdot s + {e}_{f} , where ( {e}_{f} = {D}_{f , x}^{T} \cdot [ {e}_{1} ‖ ⋯ ‖ {e}_{l} ] ) .$$

Then construct the functioned ciphertext

$${f}_{} = ( {\hat{c}}_{f} , {c}_{out} ) ∈ {ℤ}_{q}^{3 m} , where \hat{{c}_{f}} = [ {c}_{l n} \vert \vert {c}_{f} ] = {[ A \vert {B}_{f} + f ( x ) G ]}^{T} s + [ {e}_{f} \vert \vert {e}_{f} ] ∈ {ℤ}_{q}^{2 m} ;$$

S42. If ct is an evaluated ciphertext under ƒ, let ct be

$$( {( g )}^{} = ( {\hat{c}}_{f} , {c}_{o u t} ) ∈ {ℤ}_{q}^{3 m} ;$$

S43. Output μ=└(4/q)(cₒᵤₜ−R_{ƒ}·ĉ_{ƒ})┘ mod 4, where μ∈{0,1}^{m}.

For the homomorphic evaluation algorithm Eval, we describe the NAND gate computation Eval.NAND here.

S5. Eval.NAND(pp, pk_{ƒ}, ct⁽¹⁾, ct⁽²⁾)→ [symbol] ^{(g)}: On input a pk_{ƒ} and two fresh or evaluated ciphertexts, ct⁽¹⁾ that is an encryption of

$${μ}^{( 1 )} = ( {μ}_{1}^{( 1 )} , ⋯ , {μ}_{m}^{( 1 )} ) ,$$

and ct⁽²⁾ that is an encryption of

$${μ}^{( 2 )} = ( {μ}_{1}^{( 2 )} , … , {μ}_{m}^{( 2 )} ) ,$$

the homomorphic evaluation outputs a ciphertext that is an encryption of NAND(μ⁽¹⁾, μ⁽²⁾) do as follow:
S51. For each i∈(1,2), if ct⁽ⁱ⁾ is a fresh ciphertext, let it be

$${ct}_{x}^{( i )} = ( {c}_{in}^{( i )} , {c}_{1}^{( i )} , … , {c}_{l}^{( i )} , {c}_{out}^{( i )} ) ,$$

which satisfies ƒ(x⁽ⁱ⁾)=0, evaluate

$${c}_{f}^{( i )} ← {KeyEval}_{ct} ( f , {x}^{( i )} , {\{ {B}_{j} , {c}_{j}^{( i )} \}}_{j = 1}^{l} ) ,$$

construct

$$( {\hat{c}}_{f}^{( i )} = [ {c}_{in}^{( i )} ‖ {c}_{f}^{( i )} ] ∈ {ℤ}_{q}^{2 m} ) .$$

It ct⁽ⁱ⁾ is an evaluated ciphertext under ƒ, let

$${ct}^{( i )} = ( {\hat{c}}_{f}^{( i )} , {c}_{out}^{( i )} ) .$$

Then construct the functioned ciphertext

$${\hat{c}}_{f}^{( i )} , {c}_{out}^{( i )} ∈ {ℤ}_{q}^{3 m}$$

for i∈(1,2);
S52. Now we have

$${( 1 )}^{} = ( {\hat{c}}_{f}^{( 1 )} , {c}_{out}^{( 1 )} ) , and {( 2 )}^{} = ( {\hat{c}}_{f}^{( 2 )} , {c}_{out}^{( 2 )} ) .$$

Compute

$$a = {\hat{c}}_{f}^{( 1 )} + {\hat{c}}_{f}^{( 2 )} ∈ {ℤ}_{q}^{2 m} , b = ( {b}_{1} , … , {b}_{m} ) = {c}_{out}^{( 1 )} + {c}_{out}^{( 2 )} ∈ {ℤ}_{q}^{m} ;$$

S53. For each i∈[m], implement the bootstrapping

$${\overline{c}}_{1} = ( {\overline{a}}_{1} , {\overline{b}}_{i} ) ← {Bootstrap}_{( NAND )} ( {btk}_{{r}_{i}} , {ksk}_{{r}_{i}} , ( a , {b}_{i} ) ) ∈ {LWE}_{{r}_{i}}^{q / 4} ( {μ}_{i}^{( 1 )} \overline{⋀} {μ}_{i}^{( 2 )} , δ )$$

holding

$$( {\overline{a}}_{1} ∈ {ℤ}_{q}^{2 m} )$$

and (\hat{b}ᵢ∈ [symbol] ) with error bound δ;
S54. Construct

$$( {\overline{c}}_{f} = [ {\overline{a}}_{1} ‖ ⋯ ‖ {\overline{a}}_{m} ] ∈ {ℤ}_{q}^{2 m \cdot m} ) and ( {\overline{c}}_{out} = ( {\overline{b}}_{1} , … , {\overline{b}}_{m} ) ∈ {ℤ}_{q}^{m} ) ;$$

S55. Compute

$${{f}^{( g )}}_{} = {ark}_{f} \cdot [ \frac{{G}^{- 1} ( {\overline{c}}_{f} )}{{\overline{c}}_{out}} ]$$

and output

$${{f}^{( g )}}_{} = ( {\hat{c}}_{f}^{( g )} , {c}_{out}^{( g )} ) ∈ {ℤ}_{q}^{3 m} .$$

The ciphertext structure of the present FHABE embodiment is lightweight, with the size of a single-message ciphertext only being O(l log q), outperforming existing similar schemes. Further, the present FHABE embodiment satisfies selective IND-CPA security.

We also present an embodiment of the unbounded multi-hop AB-FHPRE, which serves as an extension of our unbounded FHABE into the proxy re-encryption setting.

Attribute-based PRE (AB-PRE) is a generalization of PRE, enabling fine-grained access control on both ciphertext and delegation. Specifically, (key-policy) AB-PRE allows a proxy to transform ciphertexts under some policy ƒ₁, to ciphertexts under another policy ƒ₂, realizing many-to-many encrypted data sharing.

An unbounded multi-hop AB-FHPRE scheme extends the algorithms of the FHABE=(Setup, KeyGen, Enc, Dec, Eval) scheme mentioned above by incorporating two additional algorithms, ReKeyGen and ReEnc, defined as follows:

S6. ReKeyGen (pp, sk_{ƒ}_{₁}, ƒ₁, ƒ₂)→rek_{ƒ}_{₁}_{→ƒ}_{₂}; On input a secret key sk_{ƒ}_{₁} and two policies, ƒ₁, ƒ₂. The re-encryption key generation algorithm outputs a re-encryption key rek_{ƒ}_{₁}_{→ƒ}_{₂} from ƒ₁ to ƒ₂ do as follows:
S61. Select an attribute vector y=(y₁, . . . , yₗ) such that ƒ₂ (y)=0;
S62. Construct matrices

$${\overline{M}}_{1}^{( r )} = {[ A \vert {B}_{1} + {y}_{1} G \vert … \vert {B}_{l} + {y}_{l} G ]}^{⊤} {E}_{1}^{( r )} + {\overline{E}}_{1}^{( r )} and$$

$${M}_{2} = {U}^{⊤} {E}_{1}^{( r )} + {E}_{3}^{( r )} - P 2 {( {R}_{{f}_{1}} )}^{⊤} , where {E}_{1}^{( r )} {←}^{\$} {ℤ}_{q}^{n \times 2 md} , {\overline{E}}_{2}^{( r )} ← {χ}^{( l + 1 ) m \times 2 md} , and$$

$${E}_{3}^{( r )} ← {χ}^{m \times 2 md} ;$$

S63. Evaluate D_{ƒ}_{₂}_{,y}←KeyEval_{D}(ƒ₂, y, (B₁, . . . , Bₗ)) and compute

$${M}_{1}^{( r )} = [ \begin{matrix}{I}_{m \times m} & {0}_{m \times m} \\ {0}_{l m \times m} & {D}_{{f}_{2} , y}\end{matrix} ] \cdot {\overline{M}}_{1}^{( r )} = {[ A \vert {B}_{{f}_{2}} ]}^{⊤} {E}_{1}^{( r )} + {E}_{2}^{( r )} ,$$

for some error

$${E}_{2}^{( r )}$$

satisfying ∥E₂∥_{∞}< [symbol] ·B_{χ};
S64. Output the re-encryption key:

$${rek}_{{f}_{1} \to {f}_{2}} = [ \begin{matrix}{M}_{1}^{( r )} & {0}_{2 m \times m} \\ {M}_{2}^{( r )} & {I}_{m \times m}\end{matrix} ] .$$

The ReKeyGen algorithm is run by the delegator, and the output will be sent to the proxy.

S7. ReEnc (pp, rek_{ƒ}_{₁}_{→ƒ}_{₂}, pk_{ƒ}_{₂}, ct)→ [symbol] : On input a re-encryption key rek_{ƒ}_{₁}_{→ƒ}_{₂}, a public key pk_{ƒ}_{₂}, and a ciphertext ct, outputs a ciphertext associated with ƒ₂ do as follows:
S71. If ct is a fresh ciphertext under x, as ctₓ=(cᵢₙ, c₁, . . . , cₗ, cₒᵤₜ), output ⊥ if ƒ₁ (x)≠0; Otherwise, evaluate

$${c}_{{f}_{1}} ← K e y {Eval}_{ct} ( {f}_{1} , x , {\{ {B}_{i} , {c}_{i} \}}_{i = 1}^{l} )$$

and construct the functioned ciphertext

$${{f}_{1}}_{} = ( {\hat{c}}_{{f}_{1}} , {c}_{out} ) ∈ {ℤ}_{q}^{3 m} ,$$

where ĉ_{ƒ}_{₁}=[cᵢₙ|c_{ƒ}_{₁}]; If ct is an evaluated or re-encrypted ciphertext for ƒ, output ⊥ if ƒ≠ƒ₁; Otherwise, let ct be [symbol] =(ĉ_{ƒ}_{₁}=[cᵢₙ|c_{ƒ}_{₁}], cₒᵤₜ);
S72. Compute the 1-hop re-encrypted ciphertext

$${\overline{ct}}_{{f}_{2}}^{( r )} = {rek}_{{f}_{1} \to {f}_{2}} \cdot [ \begin{matrix}{G}^{- 1} ( {\hat{c}}_{{f}_{1}} ) \\ {c}_{out}\end{matrix} ] ;$$

S73. Output the final ciphertext

$${{f}_{2}}_{( r )}^{} ← Eval . AND ( pp , {pk}_{{f}_{2}} , {\overline{ct}}_{{f}_{2}}^{( r )} , {\overline{ct}}_{{f}_{2}}^{( r )} ) .$$

The present AB-FHPRE embodiment satisfies selective IND-HRA security.

Hereinafter, we introduce more details about the FHEW bootstrapping. The bootstrapping process within the Homomorphic Evaluation Module utilizes advanced FHEW (Fully Homomorphic Encryption over the Weaker assumption) bootstrapping techniques. This integration is crucial for reducing the accumulated error of intermediate ciphertexts to a bounded value, typically denoted as B_{boot}, thereby enabling subsequent homomorphic computations and achieving unbounded circuit depth. The FHEW bootstrapping framework, as adapted here, primarily comprises three interconnected techniques: key switching, modulus switching, and homomorphic accumulator.

For the key switching: this technique is configured to convert an LWE (Learning With Errors) encryption under a first secret key s₁ to an LWE encryption under a second secret key s₂. In homomorphic evaluation, intermediate ciphertexts might result from computations involving different internal keys or representations. Key switching allows for the efficient transformation of such ciphertexts under an “old” key to a “new” key, usually a simpler or refreshed key, without decrypting the underlying message. This is typically achieved by encrypting the “old” secret key under the “new” public key and using this encryption to re-encrypt the original ciphertext. For an LWE ciphertext (a, b) encrypting a message m under secret key s₁, key switching aims to produce (a′, b′) encrypting m under s₂. This process involves a key switching key kskₛ_{₁}_{→s}_{₂} that bundles encryptions of elements of s₁ under s₂. The operation usually involves decomposing basis elements and sums, such that the resulting ciphertext still resembles an LWE encryption with bounded noise. This conversion is vital for standardizing ciphertexts during complex evaluations.

For modulus switching: this technique is configured to convert an LWE encryption under a first modulus q₁ to an LWE encryption under a second, smaller modulus q₂, where q₂<q₁. Homomorphic operations cause noise to grow multiplicatively. To manage this noise and keep ciphertext components within manageable bounds, their coefficients often need to be reduced. Modulus switching helps to scale down the ciphertext components and their associated noise, effectively “compressing” the ciphertext and its error term. While reducing the modulus, the underlying plaintext message, appropriately scaled, must be preserved. This is performed by multiplying the ciphertext elements by q₂/q₁ and then rounding the result. However, care must be taken as this process slightly increases the noise, which is then managed by the subsequent bootstrapping steps. The ability to reduce the ciphertext modulus without compromising security or correctness is essential for controlling noise and maintaining efficiency.

Homomorphic Accumulator: The homomorphic accumulator is configured to process GSW (Gentry-Sahai-Waters) ciphertexts. In the context of FHEW bootstrapping, LWE ciphertexts encrypting single bits are often converted into GSW-like ciphertexts to perform homomorphic evaluations of lookup tables. The accumulator essentially evaluates a decryption circuit homomorphically. It takes an LWE ciphertext (which can be viewed as an encryption of a point value) and homomorphically evaluates a polynomial that decrypts this point to recover the underlying message bit. This process typically involves converting the LWE ciphertext into a more structured GSW-like ciphertext through a “gadget” matrix. The homomorphic accumulator then performs additions and multiplications of these GSW ciphertexts to implement the decryption process, effectively evaluating the “key” (secret key) as a polynomial within the encrypted domain. The output is a new LWE ciphertext, usually with a refreshed, smaller noise bound, encrypting the original message bit. This step often uses a dedicated “test polynomial” or “functional bootstrapping” approach to homomorphically recover the message bit and re-encrypt it with less noise.

By combining these three techniques, the Bootstrapping Unit efficiently refreshes the noise in a ciphertext component, reducing it to a controlled, bounded value B_{boot}. This renewed ciphertext component then becomes suitable for further homomorphic operations or, critically, for recovery by the ARK Application Unit to its standard form, ensuring the system's capacity for unbounded circuit depth. The integration of the FHEW framework significantly enhances the practicality and security of the FHABE scheme provided by the present disclosure.

While the present invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. The detailed description provided herein represents the best mode of practicing the invention as currently contemplated by the inventors, and variations and adaptations that would be apparent to those skilled in the art are intended to be included within the scope of the invention.

What is claimed is:

1. A computer-implemented system for fully homomorphic attribute-based encryption (FHABE) with unbounded circuit depth, comprising:
a processor configured to execute instructions; and
a memory coupled to the processor and storing instructions configured to cause the processor to perform operations comprising:
generating public parameters including matrices A, B₁, . . . , Bₗ, U and Gadget matrix G=Iₙ⊗g^{T}, and a master secret key msk;
generating a secret key sk_{ƒ} for an access policy ƒ and an associated public key pk_{ƒ}, wherein the associated public key pk_{ƒ} includes an auxiliary recovery key ark_{ƒ};
encrypting an attribute vector
$$x ∈ {ℤ}_{q}^{l}$$
and a message μ∈(0,1)^{m} associated with the access policy ƒ into a ciphertext ctₓ;
homomorphically evaluating an operation on one or more of the ciphertexts to produce an evaluated ciphertext, wherein the homomorphic evaluation comprises:
performing a homomorphic arithmetic or logical operation on ciphertext components to achieve a resulting ciphertext component;
performing a bootstrapping process on the resulting ciphertext component, wherein the bootstrapping process is configured to refresh noise associated with the resulting ciphertext component; and
applying the auxiliary recovery key ark_{ƒ} to a noise-refreshed ciphertext component to recover the evaluated ciphertext to a standard form compatible with subsequent homomorphic evaluation or decryption; and
decrypting a recovered ciphertext ct using the secret key sk_{ƒ} to retrieve the message μ, wherein correctness of the decryption is maintained for ciphertexts evaluated over an unbounded number of operations.

2. The system of claim 1, wherein the bootstrapping process utilizes FHEW bootstrapping techniques.

3. The system of claim 2, wherein the FHEW bootstrapping techniques comprise:
key switching, configured to convert an LWE encryption under a first secret key to an LWE encryption under a second secret key;
modulus switching, configured to convert an LWE encryption under a first modulus to an LWE encryption under a second modulus; and
a homomorphic accumulator, configured to process GSW ciphertexts.

4. The system of claim 3, wherein the bootstrapping process performs a logical NAND operation, and further comprises:
performing a homomorphic addition on first and second LWE ciphertext components (a⁽¹⁾, b⁽¹⁾) and (a⁽²⁾, b⁽²⁾), under a secret key s and a plaintext modulus t=4, to generate a summed LWE ciphertext component (a, b) that encrypts a sum of plaintext messages μ⁽¹⁾+μ⁽²⁾, wherein the homomorphic addition increases an associated error bound to q/8; and
applying a mapping function ƒ to a value x=b− [symbol] a, s [symbol] of the summed LWE ciphertext component (a, b) via a homomorphic accumulator using a bootstrapping key btk and a key switching key ksk, wherein the mapping function ƒ is configured to transform:
$$x to q / 8 , if x ∈ [ - q / 8 , 3 q / 8 ) ;$$
$$and$$
$$x to - q / 8 , if x ∈ [ 3 q / 8 , 7 q / 8 ) ;$$
whereby the mapped value reflects a result of the NAND operation μ⁽¹⁾NANDμ⁽²⁾ with an associated error bound reduced to q/16, wherein q is the ciphertext modulus.

5. The system of claim 1, wherein the auxiliary recovery key ark_{ƒ} is configured to recover a bootstrapped ciphertext from an expanded key form to a functional ciphertext form compatible with a decryption or homomorphic evaluation algorithm, and wherein:
the auxiliary recovery key arks comprises a matrix structured as:
$${ark}_{f} = [ \begin{matrix}{M}_{1} & {0}_{2 , m \times m} \\ {M}_{2} & {I}_{m \times m}\end{matrix} ] ∈ {ℤ}_{q}^{3 m \times ( 2 mmd + m )}$$
where, M₁=[A|B_{ƒ}]^{T}E₁+E₂, M₂=U^{T}E₁+E₃−P2(\hat{R}_{ƒ})^{T}, E₁ is a randomly chosen matrix uniformly sampled from [symbol] , E₂ and E₃ are error matrices sampled from an error distribution χ with bound B_{χ}, A, B_{ƒ}, U are public parameter matrices defined in the system, with
$$A ∈ {ℤ}_{q}^{n \times m} , {B}_{f} ∈ {ℤ}_{q}^{n \times m} ︶ U ∈ {ℤ}_{q}^{n \times m} ,$$
R̅_{ƒ} is an expanded key matrix after bootstrapping, and
recovering the bootstrapped ciphertext involves computing the functional ciphertext form
$${f}_{( g )}^{}$$
via the matrix multiplication:
$${f}_{( g )}^{} = {ark}_{f} \cdot [ \begin{matrix}{G}^{- 1} ( {\overline{c}}_{f} ) \\ {\overline{c}}_{out}\end{matrix} ]$$
where c̅_{ƒ} and c̅ₒᵤₜ are components of the bootstrapped ciphertext in the expanded key form, with
$${\overline{c}}_{f} ∈ {ℤ}_{q}^{2 mm} , {\overline{c}}_{out} ∈ {ℤ}_{q}^{m} ,$$
G⁻¹ is the inverse algorithm of the gadget matrix G, which decomposes a vector into a binary representation;
the functional ciphertext form
$${f}_{( g )}^{}$$
after recovery has an associated error term with a bound less than q/16, where q is the ciphertext modulus, thereby enabling correct decryption and further homomorphic evaluation for unbounded-depth circuits without exceeding the error tolerance; and
the auxiliary recovery key ark_{ƒ} is utilized within an Eval.NAND algorithm to restore ciphertexts after homomorphic evaluation of a NAND gate, enabling their use in subsequent unbounded-depth circuit evaluations.

6. The system of claim 5, wherein the homomorphic evaluation comprises the Eval.NAND algorithm, and the bootstrapping process is performed on each component of a message vector, wherein:
the Eval.NAND algorithm operates on functioned ciphertexts
$${f}_{( i )}^{} = ( {\hat{c}}_{f}^{( i )} , {c}_{out}^{( i )} ) ∈ {ℤ}_{q}^{3 m}$$
for j∈{1,2}, each encrypting a message vector
$${μ}^{( j )} = ( {μ}_{1}^{( j )} , … , {μ}_{m}^{( j )} ) ∈ {\{ 0 , 1 \}}^{m}$$
for j∈{1,2}, and comprises:
computing a homomorphic addition
$$a = {\hat{c}}_{f}^{( 1 )} + {\hat{c}}_{f}^{( 2 )} ∈ {ℤ}_{q}^{2 m} , b = ( {b}_{1} , … , {b}_{m} ) = {c}_{out}^{( 1 )} + {c}_{out}^{( 2 )} ∈ {ℤ}_{q}^{m} ;$$
for each component i∈[m], performing a bootstrapping process
$${\overline{c}}_{i} = ( {\overline{a}}_{i} , {\overline{b}}_{i} ) ← {Bootstrap}_{( NAND )} ( {btk}_{{r}_{i}} , {ksk}_{{r}_{i}} , ( a , {b}_{i} ) ) ∈ {LWE}_{{r}_{i}}^{4 / q} ( {μ}_{i}^{( 1 )} \overline{⋀} {μ}_{i}^{( 2 )} , δ ) ,$$
where btkᵣ_{ᵢ} is a bootstrapping key and kskᵣ_{ᵢ} is a key-switching key associated with a secret key component rᵢ;
the bootstrapping process is performed independently for each component i∈[m], resulting in a bootstrapped ciphertext c̅t=(c̅_{ƒ}, c̅ₒᵤₜ) with
$${\overline{c}}_{f} = [ {\overline{a}}_{1} \vert ⋯ \vert {\overline{a}}_{m} ] ∈ {ℤ}_{q}^{2 mm} and {\overline{c}}_{out} = ( {\overline{b}}_{1} , ⋯ , {\overline{b}}_{m} ) ∈ {ℤ}_{q}^{m} ,$$
wherein the error bound for each component satisfies δ≤q/16; and
the component-wise bootstrapping enables parallel processing and maintains an overall error bound below q/16, supporting correct decryption and further homomorphic evaluation for unbounded-depth circuits.

7. The system of claim 1, wherein the system is configured to, during the generation of the public parameters in the Setup algorithm and during the homomorphic evaluation process in the Eval algorithm, select parameters that satisfy predefined error bounds to maintain correctness of the encryption scheme, wherein
the error bound for fresh ciphertexts is given by
$${B}_{χ} + 2 m σ ( {α}_{ℱ} + 1 ) {B}_{χ} < \frac{q}{8} ,$$
where B_{χ} is the bound of the error distribution χ, σ is the key sampling parameter used in the SampleD algorithm for generating secret keys, [symbol] =(m+ [symbol] is a policy depth factor with [symbol] being the maximum depth of supported policy circuits, m is the dimension parameter such that m=Θ(n log q), and q is the ciphertext modulus, the chosen parameters, with overwhelming probability, satisfies
$$‖ {e}_{out}^{( i )} - {R}_{f}^{T} [ {e}_{in}^{( i )} \vert {e}_{f}^{( i )} ] ‖ < {B}_{χ} + 2 m σ ( {α}_{ℱ} + 1 ) {B}_{χ} < \frac{q}{I 6}$$
for any fresh ciphertext; and
the error bound for evaluated ciphertexts is given by
$$2 {m}^{2} d \cdot {B}_{χ} + δ + 2 m σ \cdot 2 {m}^{2} {d}_{g} \cdot {α}_{ℱ} {B}_{χ} < \frac{q}{16} ,$$
where d_{g}=┌log_{B}_{_{g}} q┐ is the gadget base decomposition dimension with B_{g} being a gadget base, σ represents an error bound introduced during the bootstrapping process;
satisfying these error bounds allows the system to maintain correctness for homomorphic evaluations of circuits with unbounded depth, without requiring circuit-depth-dependent parameter scaling.

8. The system of claim 1, wherein the ciphertext ctₓ for a message μ∈{0,1}^{m} associated with an attribute vector
$$x = ( {x}_{1} , … , {x}_{l} ) ∈ {ℤ}_{q}^{l}$$
comprises components ctₓ=(cᵢₙ, c₁, . . . , cₗ, cₒᵤₜ) and wherein:
parameters and matrices are defined with dimensions:
$$A ∈ {ℤ}_{q}^{n \times m} , {B}_{i} ∈ {ℤ}_{q}^{n \times m} for i ∈ [ l ] , u ∈ {ℤ}_{q}^{n \times m} , and G ∈ {ℤ}_{q}^{n \times m}$$
is a gadget matrix, wherein the ciphertext vector overall belongs to
$${ℤ}_{q}^{( l + 2 ) m} ,$$
and m=Θ(n┌log q┐) as per the Setup algorithm;
the mathematical forms and dimensions of the ciphertext components are:
$${c}_{in} = {A}^{⊤} S + {e}_{in} ∈ {ℤ}_{q}^{m} , where s ∈ {ℤ}_{q}^{n}$$
is a random vector;
for each i∈[l],
$${c}_{i} = {( {B}_{i} + {x}_{i} G )}^{⊤} s + {e}_{i}^{⊤} ∈ {ℤ}_{q}^{m} ; {c}_{out} = {U}^{⊤} s + {e}_{out} + ⌊ q / 4 ⌋ \cdot μ ∈ {ℤ}_{q}^{m} ,$$
where μ is encoded coordinate-wise;
error distributions and bounds: the vectors eᵢₙ, eᵢ for i∈[l] and eₒᵤₜ are independently sampled from an error distribution χ with a constant bound B_{χ} such that ∥eᵢₙ∥_{∞}<B_{χ}, ∥eᵢ∥_{∞}≤B_{χ}, and ∥eₒᵤₜ∥_{∞}≤B_{χ}, wherein parameter selection during Setup and Eval ensures this bound for correctness;
attribute association: for each i∈[l], the component cᵢ embeds the attribute xᵢ directly, enabling subsequent key-homomorphic evaluation algorithms KeyEval_{ct} or KeyEval_{D} to process access-controlled information based on x;
KeyEval_{ct} result and error bound: for a policy ƒ and attribute x,
$${KeyEval}_{ct} ( f , x , {\{ {B}_{i} , {c}_{i} \}}_{i = 1}^{l} ) \to {c}_{f} = {D}_{f , x}^{⊤} \cdot [ {c}_{1} ‖ … ‖ {c}_{l} ] ∈ {ℤ}_{q}^{m} ,$$
and c_{ƒ}=[B_{ƒ}+ƒ(x) G]^{T}·s+e_{ƒ}, where ∥e_{ƒ}∥_{∞}≤(m+ [symbol] ·B with [symbol] being the depth of the policy circuit ƒ, ensuring that the functioned ciphertext construction supports correct Eval and decryption.

9. A computer-implemented system for unbounded multi-hop attribute-based fully homomorphic proxy re-encryption (AB-FHPRE), comprising:
a processor configured to execute instructions; and
a memory coupled to the processor and storing instructions configured to cause the processor to perform operations comprising:
generating public parameters including matrices A, B₁, . . . , Bₗ, U, and Gadget matrix G, and a master secret key msk;
generating a secret key sk_{ƒ} for a first access policy ƒ₁ and an associated public key pk_{ƒ}, wherein the associated public key pk_{ƒ} includes an auxiliary recovery key ark_{ƒ} for the first access policy ƒ₁;
encrypting an attribute vector
$$x ∈ {ℤ}_{q}^{l}$$
and a message μ∈(0,1)^{m} associated with the first access policy ƒ₁ into a ciphertext ct;
generating a re-encryption key rek_{ƒ}_{₁}_{→ƒ}_{₂} for transforming the ciphertext ct from the first access policy ƒ₁ to a second access policy ƒ₂, wherein the re-encryption key rek_{ƒ}_{₁}_{→ƒ}_{₂} is a matrix that combines policy-associated matrices and error matrices, enabling a proxy computing device to convert ciphertexts associated with the first access policy ƒ₁ to those associated with the second access policy ƒ₂ without accessing plaintext; and
re-encrypting, by the proxy computing device, the ciphertext from the first access policy ƒ₁ to the second access policy ƒ₂ using the re-encryption key rek_{ƒ}_{₁}_{→ƒ}_{₂} and a public key of the second policy, wherein the re-encryption comprises:
transforming the ciphertext under the first access policy ƒ₁ into an intermediate re-encrypted ciphertext; and
performing a homomorphic AND computation on the intermediate re-encrypted ciphertext, wherein the homomorphic AND computation includes a bootstrapping process to refresh noise and produce a re-encrypted ciphertext for the second access policy ƒ₂, and wherein the re-encryption supports an unbounded number of re-encryption hops.

10. The system of claim 9, wherein the re-encryption key is generated by the ReKeyGen algorithm and used by the ReEnc algorithm to re-encrypt a ciphertext under policy ƒ₁ to a ciphertext under policy ƒ₂, and wherein:
the re-encryption key rek_{ƒ}_{₁}_{→ƒ}_{₂} is a block matrix structured as:
$${rek}_{{f}_{1} \to {f}_{2}} = [ \begin{matrix}{M}_{1}^{( r )} & {0}_{2 m \times m} \\ {M}_{2}^{( r )} & {I}_{m \times m}\end{matrix} ] ∈ {ℤ}_{q}^{3 m \times ( 2 m \cdot d + m )}$$
where d=┌log_{B}_{_{g}} q┐ is the decomposition length determined by a gadget base B_{g}, and m=Θ(n log q) is the dimension parameter;
the components
$${M}_{1}^{( r )} and {M}_{2}^{( r )}$$
are constructed as follows:
select an attribute vector
$$y = ( {y}_{1} , … , {y}_{l} ) ∈ {ℤ}_{q}^{l}$$
such that ƒ₂(y)=0;
construct an intermediate matrix
$${\overline{M}}_{1}^{( r )} = {[ A \vert {B}_{1} + {y}_{1} G \vert … \vert {B}_{l} + {y}_{l} G ]}^{T} {E}_{1}^{( r )} + {\overline{E}}_{1}^{( r )} ,$$
$$where {E}_{1}^{( r )} {←}^{\$} {ℤ}_{q}^{n \times 2 m d}$$
is a random matrix,
$${\overline{E}}_{2}^{( r )} ← {χ}^{( l + 1 ) m \times 2 m d}$$
is an error matrix sampled from distribution χ with bound B_{χ};
evaluate D_{ƒ}_{₂}_{,y}←KeyEval_{D}(ƒ₂, y, (B₁, . . . , Bₗ)), and compute:
$${M}_{1}^{( r )} = {[ \begin{matrix}{I}_{m \times m} & {0}_{m \times m} \\ {0}_{l m \times m} & {D}_{{f}_{2} , y}\end{matrix} ]}^{T} \cdot {\overline{M}}_{1}^{( r )} = {[ A \vert {B}_{{f}_{2}} ]}^{T} {E}_{1}^{( r )} + {E}_{2}^{( r )}$$
$$where {E}_{2}^{( r )}$$
is an error matrix satisfying ∥E₂∥_{∞}< [symbol] ·B_{χ}, α_{F}=(m+ [symbol] is a policy depth factor with [symbol] being the maximum depth of supported policies;
compute
$${M}_{2}^{( r )} = {U}^{T} {E}_{1}^{( r )} + {E}_{3}^{( r )} - P 2 {( {R}_{{f}_{1}} )}^{T} , where {E}_{3}^{( r )} ← {χ}^{m \times 2 m d}$$
is an error matrix,
$${R}_{{f}_{1}} ∈ {ℤ}_{q}^{2 m \times m}$$
is the secret key tor policy ƒ₁, P2 is a public algorithm such that P2(X)=G^{T}X for any matrix X;
the ReEnc algorithm uses rek_{ƒ}_{₁}_{→ƒ}_{₂} and the gadget inverse to compute a 1-hop re-encrypted ciphertext
$${\overline{c t}}_{{f}_{2}}^{( r )} = r e {k}_{{f}_{1} \to {f}_{2}} \cdot [ \begin{matrix}{G}^{-} ( {\hat{c}}_{{f}_{1}} ) \\ {c}_{out}\end{matrix} ]$$
$$where {\hat{c}}_{{f}_{1}} ∈ {ℤ}_{q}^{2 m} and {c}_{out} ∈ {ℤ}_{q}^{m}$$
are components of the input functioned ciphertext under ƒ₁, and G⁻¹ is the gadget inverse algorithm satisfying G·G⁻¹(x)=x;
the matrices and error terms are sampled with respect to public parameters pp including modulus q, gadget matrix G, error distribution χ, and bound B_{χ} such that the accumulated error after re-encryption satisfies ∥error∥_{∞}<q/16, enabling correct decryption; subsequently, a homomorphic refresh operation reduces the error to a level suitable for further re-encryption or homomorphic evaluation, thereby supporting multi-hop re-encryption with unbounded hops;
the re-encryption key rek_{ƒ}_{₁}_{→ƒ}_{₂} is generated by ReKeyGen using the master secret key sk_{ƒ}_{₁} and public parameters pp, and consumed by ReEnc in conjunction with the public key pk_{ƒ}_{₂} to map ciphertexts from policy ƒ₁ to policy ƒ₂.

11. A computer-implemented method for unbounded depth fully homomorphic attribute-based encryption (FHABE), the method comprising:
generating, by a computing device, public parameters including matrices A, B₁, . . . , Bₗ, U, and Gadget matrix G, and a master secret key msk=T_{A};
generating, by the computing device, a secret key sk_{ƒ} for an access policy ƒ and an associated public key pk_{ƒ}, wherein the associated public key pk_{ƒ} includes an auxiliary recovery key ark_{ƒ};
encrypting, by the computing device, an attribute vector
$$x ∈ {ℤ}_{q}^{l}$$
and a message μ∈(0,1)^{m} associated with the access policy ƒ into a ciphertext ct;
homomorphically evaluating, by the computing device, an operation on one or more of the attribute-based ciphertexts to produce an evaluated ciphertext, wherein the homomorphic evaluation comprises:
performing a homomorphic arithmetic or logical operation on ciphertext components to achieve a resulting ciphertext component;
performing a bootstrapping process on the resulting ciphertext component, wherein the bootstrapping process is configured to refresh noise associated with the resulting ciphertext component; and
applying the auxiliary recovery key ark_{ƒ} to a noise-refreshed ciphertext component to recover the evaluated ciphertext to a standard form compatible with subsequent homomorphic evaluation or decryption; and
decrypting the ciphertext ct using the secret key sk_{ƒ} to retrieve the message μ, wherein correctness of the decryption is maintained for ciphertexts evaluated over an unbounded number of operations.

12. The method of claim 11, wherein the bootstrapping process utilizes FHEW bootstrapping techniques.

13. The method of claim 12, wherein the FHEW bootstrapping techniques comprise:
key switching, configured to convert an LWE encryption under a first secret key to an LWE encryption under a second secret key;
modulus switching, configured to convert an LWE encryption under a first modulus to an LWE encryption under a second modulus; and
a homomorphic accumulator, configured to process GSW ciphertexts.

14. The method of claim 13, wherein the bootstrapping process performs a logical NAND operation, and further comprises:
performing a homomorphic addition on first and second LWE ciphertext components (a⁽¹⁾, b⁽¹⁾) and (a⁽²⁾, b⁽²⁾), under a secret key s and a plaintext modulus t=4, to generate a summed LWE ciphertext component (a, b) that encrypts a sum of plaintext messages μ⁽¹⁾+μ⁽²⁾, wherein the homomorphic addition increases an associated error bound to q/8; and
applying a mapping function ƒ to a value x=b− [symbol] a, s [symbol] of the summed LWE ciphertext component (a, b) via a homomorphic accumulator using a bootstrapping key btk and a key switching key ksk, wherein the mapping function ƒ is configured to transform:
$$x to q / 8 , if x ∈ [ - q / 8 , 3 q / 8 ) ; and$$
$$x to - q / 8 , if x ∈ [ 3 q / 8 , 7 q / 8 ) ;$$
whereby the mapped value reflects a result of the NAND operation μ⁽¹⁾NANDμ⁽²⁾ with an associated error bound reduced to q/16, wherein q is the ciphertext modulus.

15. The method of claim 11, wherein the auxiliary recovery key ark_{ƒ} is configured to recover a bootstrapped ciphertext from an expanded key form to a functional ciphertext form compatible with a decryption or homomorphic evaluation algorithm, and wherein:
the auxiliary recovery key ark comprises a matrix structured as:
$$a r {k}_{f} = [ \begin{matrix}{M}_{1} & {0}_{2 , m \times m} \\ {M}_{2} & {I}_{m \times m}\end{matrix} ] ∈ {ℤ}_{q}^{3 m \times ( 2 m m d + m )}$$
where, M₁=[A|B_{ƒ}]^{T}E₁+E₂, M₂=U^{T}E₁+E₃−P2(R̅_{ƒ})^{T}, E₁ is a randomly chosen matrix uniformly sampled from [symbol] , E₂ and E₃ are error matrices sampled from an error distribution χ with bound B_{χ}, A, B_{ƒ}, U are public parameter matrices defined in the system, with
$$A ∈ {ℤ}_{q}^{n \times m} , {B}_{f} ∈ {ℤ}_{q}^{n \times m} and U ∈ {ℤ}_{q}^{n \times m} ,$$
R_{ƒ} is an expanded key matrix after bootstrapping, and
recovering the bootstrapped ciphertext involves computing the functional ciphertext form
$${f}_{( g )}^{}$$
via the matrix multiplication:
$${f}_{( g )}^{} = {ark}_{f} \cdot [ \begin{matrix}{G}^{- 1} ( {\overline{c}}_{f} ) \\ {\overline{c}}_{out}\end{matrix} ]$$
where c̅_{ƒ} and c̅ₒᵤₜ are components of the bootstrapped ciphertext in the expanded key form, with
$${\overline{c}}_{f} ∈ {ℤ}_{q}^{2 m m} , {\overline{c}}_{out} ∈ {ℤ}_{q}^{m} ,$$
G⁻¹ is the inverse algorithm of the gadget matrix G, which decomposes a vector into a binary representation;
the functional ciphertext form
$${f}_{( g )}^{}$$
after recovery has an associated error term with a bound less than q/16, where q is the ciphertext modulus, thereby enabling correct decryption and further homomorphic evaluation for unbounded-depth circuits without exceeding the error tolerance; and
the auxiliary recovery key ark_{ƒ} is utilized within an Eval.NAND algorithm to restore ciphertexts after homomorphic evaluation of a NAND gate, enabling their use in subsequent unbounded-depth circuit evaluations.

16. The method of claim 15, wherein the homomorphic evaluation comprises the Eval.NAND algorithm, and the bootstrapping process is performed on each component of a message vector, wherein:
the Eval.NAND algorithm operates on functioned ciphertexts
$$\hat{c} {t}_{f}^{( i )} = ( {\hat{c}}_{f}^{( i )} , {c}_{out}^{( i )} ) ∈ {ℤ}_{q}^{3 m}$$
for i∈{1,2}, each encrypting a message vector
$${μ}^{( j )} = ( {μ}_{1}^{( j )} , … , {μ}_{m}^{( j )} ) ∈ {\{ 0 , 1 \}}^{m}$$
for j∈{1,2}, and comprises:
computing a homomorphic addition
$$a = {\hat{c}}_{f}^{( 1 )} + {\hat{c}}_{f}^{( 2 )} ∈ {ℤ}_{q}^{2 m} , b = ( {b}_{1} , … , {b}_{m} ) = {c}_{out}^{( 1 )} + {c}_{out}^{( 2 )} ∈ {ℤ}_{q}^{m} ;$$
for each component i∈[m], performing a bootstrapping process c̅ᵢ=(āᵢ, b̅ᵢ)←Bootstrap_{(NAND)}(btkᵣ_{ᵢ}, kskᵣ_{ᵢ}, (a, bᵢ))∈
$$L W {E}_{{r}_{i}}^{4 / q} ( {μ}_{i}^{( 1 )} \overline{⋀} {μ}_{i}^{( 2 )} , δ ) ,$$
where btkᵣ_{ᵢ} is a bootstrapping key and kskᵣ_{ᵢ} is a key-switching key associated with a secret key component rᵢ;
the bootstrapping process is performed independently for each component i∈[m], resulting in a bootstrapped ciphertext c̅t=(c̅_{ƒ}, c̅ₒᵤₜ) with
$${\overline{c}}_{f} = [ {\overline{a}}_{1} \vert … \vert {\overline{a}}_{m} ] ∈ {ℤ}_{q}^{2 m m} and {\overline{c}}_{o u t} = ( {\overline{b}}_{1} , … , {\overline{b}}_{m} ) ∈ {ℤ}_{q}^{m} ,$$
wherein the error bound for each component satisfies δ≤q/16; and
the component-wise bootstrapping enables parallel processing and maintains an overall error bound below q/16, supporting correct decryption and further homomorphic evaluation for unbounded-depth circuits.

17. The method of claim 11, wherein the system is configured to, during the generation of the public parameters in the Setup algorithm and during the homomorphic evaluation process in the Eval algorithm, select parameters that satisfy predefined error bounds to maintain correctness of the encryption scheme, wherein
the error bound for fresh ciphertexts is given by
$${B}_{χ} + 2 m σ ( {α}_{ℱ} + 1 ) {B}_{χ} < \frac{q}{8} ,$$
where B_{χ} is the bound of the error distribution χ, σ is the key sampling parameter used in the SampleD algorithm for generating secret keys, [symbol] =(m+ [symbol] is a policy depth factor with [symbol] being the maximum depth of supported policy circuits, m is the dimension parameter such that m=Θ(n log q), and q is the ciphertext modulus, the chosen parameters, with overwhelming probability, satisfies
$$‖ {e}_{out}^{( i )} - {R}_{f}^{T} [ {e}_{i n}^{( i )} \vert {e}_{f}^{( i )} ] ‖ < {B}_{χ} + 2 m σ ( {α}_{ℱ} + 1 ) {B}_{χ} < \frac{q}{16}$$
for any fresh ciphertext; and
the error bound for evaluated ciphertexts is given by
$$2 {m}^{2} d \cdot {B}_{X} + δ + 2 m σ \cdot 2 {m}^{2} {d}_{g} \cdot {α}_{ℱ} {B}_{X} < \frac{q}{I 6} .$$
where d_{g}=┌log_{B}_{_{g}} q┐ is the gadget base decomposition dimension with B_{g} being a gadget base, σ represents an error bound introduced during the bootstrapping process;
satisfying these error bounds allows the system to maintain correctness for homomorphic evaluations of circuits with unbounded depth, without requiring circuit-depth-dependent parameter scaling.

18. The method of claim 11, wherein the ciphertext ctₓ for a message μ∈{0,1}^{m} associated with an attribute vector
$$x = ( {x}_{1} , … , {x}_{l} ) ∈ {ℤ}_{q}^{l}$$
comprises components ctₓ=(cᵢₙ, c₁, . . . , cₗ, cₒᵤₜ) and wherein:
parameters and matrices are defined with dimensions:
$$A ∈ {ℤ}_{q}^{n \times m} , {B}_{i} ∈ {ℤ}_{q}^{n \times m} for i ∈ [ l ] , U ∈ {ℤ}_{q}^{n \times m} , and G ∈ {ℤ}_{q}^{n \times m}$$
is a gadget matrix, wherein the ciphertext vector overall belongs to
$${ℤ}_{q}^{( l + 2 ) m} ,$$
and m=Θ(n┌log q┐) as per the Setup algorithm;
the mathematical forms and dimensions of the ciphertext components are:
$${c}_{i n} = {A}^{⊤} s + {e}_{i n} ∈ {ℤ}_{q}^{m} , where s ∈ {ℤ}_{q}^{n}$$
is a random vector;
for each i∈[l],
$${c}_{i} = {( {B}_{i} + {x}_{i} G )}^{⊤} s + {e}_{i}^{⊤} ∈ {ℤ}_{q}^{m} ;$$
$${c}_{out} = {U}^{⊤} s + {e}_{out} + ⌊ q / 4 ⌋ \cdot μ ∈ {ℤ}_{q}^{m} ,$$
where μ is encoded coordinate-wise;
error distributions and bounds: the vectors eᵢₙ, eᵢ for i∈[l] and eₒᵤₜ are independently sampled from an error distribution χ with a constant bound B_{χ} such that ∥eᵢₙ∥_{∞}≤B_{χ}, ∥eᵢ∥_{∞}≤B_{χ}, and ∥eₒᵤₜ∥_{∞}≤B_{χ}, wherein parameter selection during Setup and Eval ensures this bound for correctness;
attribute association: for each i∈[l], the component cᵢ embeds the attribute xᵢ directly, enabling subsequent key-homomorphic evaluation algorithms KeyEval_{ct} or KeyEval_{D} to process access-controlled information based on x;
KeyEval_{ct} result and error bound: for a policy ƒ and attribute x,
$$K {eyEval}_{ct} ( f , x , {\{ {B}_{i} , {c}_{i} \}}_{i = 1}^{l} ) \to {c}_{f} = {D}_{f , x}^{T} \cdot [ {c}_{1} ‖ … ‖ {c}_{l} ] ∈ {ℤ}_{q}^{m} ,$$
and c_{ƒ}=[B_{ƒ}+ƒ(x) G]^{T}·s+e_{ƒ}, where ∥e_{ƒ}∥_{∞}≤(m+ [symbol] ·B with [symbol] being the depth of the policy circuit ƒ, ensuring that the functioned ciphertext construction supports correct Eval and decryption.
